(19) United States
(12) Patent Application Publication
(10) Pub. No.: US 2011/0261471 A1
(43) Pub. Date: Oct. 27, 2011

(54) IMAGE PICKUP LENS, IMAGE PICKUP APPARATUS, AND PORTABLE TERMINAL DEVICE

(75) Inventor: Minoru TANIYAMA, Saitama-shi (JP)

(73) Assignee: FUJIFILM CORPORATION, Tokyo (JP)

(21) Appl. No.: 13/094,337

(22) Filed: Apr. 26, 2011

(30) Foreign Application Priority Data
Apr. 26, 2010 (JP) 2010-101150

(51) Int. Cl. G02B 13/18; G02B 9/34

(52) U.S. Cl. 359/715; 359/773

(57) ABSTRACT

An image pickup lens that includes the following disposed from an object side in the order listed below: a first lens having a positive refractive power; a second lens having a negative refractive power; a third lens having a positive refractive power; and a fourth lens having an object side surface which is concave or flat adjacent to an optical axis of the lens and a negative refractive power adjacent to the optical axis, and satisfies Conditional Expression (1) given below in order to realize total length reduction and high image forming performance.

0.3<|(R4+R3)/(R4−R3)|<1.5 (1)

where, R3 is a paraxial radius of curvature of an object side surface of the second lens, and R4 is a paraxial radius of curvature of an image side surface of the second lens.

### BACKGROUND OF THE INVENTION

1. Field of the Invention

The present invention relates to an image pickup lens for forming an optical image of a subject on an image sensor, such as a CCD (charge coupled device), a CMOS (complementary metal oxide semiconductor), or the like, and an image pickup apparatus having the image pickup lens mounted thereon to perform imaging, such as a digital still camera or the like. The invention also relates to a portable terminal device, such as a camera-equipped cell phone, a personal digital assistance (PDA), or the like.

2. Description of the Related Art

Recently, along with the spread of personal computers to homes and the like, digital still cameras capable of inputting image information obtained by imaging a landscape, a person, or the like to a personal computer have been spreading rapidly. In addition, more and more cell phones have built-in camera modules for image input. Such devices with imaging capabilities employ image sensors such as CCDs, CMOSs, and the like. In recent years, these types of image sensors have been downsized greatly and, consequently, imaging devices as a whole and image pickup lenses to be mounted on the devices have also been required to have more compact sizes. At the same time, the pixel count of image sensors has been increasing, thereby causing a growing demand for improvement of image pickup lenses in resolution and performance.

Image pickup lenses, each formed of three or four lenses, are disclosed in U.S. Pat. Nos. 6,476,982, 7,466,497, 7,715,119, 7,453,654, and 7,633,690, and U.S. Patent Application Publication No. 2009015944, as well as in Japanese Unexamined Patent Publication Nos. 2007-017984, and 2009-020182. As described in these documents, for a four-element image pickup lens, in particular, a configuration of positive, negative, positive, and positive power arrangement from the object side or a configuration of positive, negative, positive, and negative power arrangement from the object side is known. In the case of such four-element image pickup lenses, the object side surface of the most image side lens often has a convex shape in a paraxial region (adjacent to the optical axis). In the mean time, Japanese Unexamined Patent Publication No. 2007-017984 discloses, in Examples 5 and 9, a configuration of positive, negative, positive, and negative power arrangement with the object side surface of the most image side lens having a concave shape adjacent to the optical axis of the lens.

As described above, downsizing and pixel count increase have been in progress for recent image sensors. For image pickup lenses of portable camera modules, in particular, cost reduction and compactness have been the major demands, but as the pixel count of image sensors even for portable camera modules tends to be increased, a demand for performance improvement is also growing. Consequently, development of wide variety of lenses comprehensively taking into account the cost, performance, and compactness is anticipated, and from the viewpoint of performance, development of inexpensive and high performance image pickup lenses with a perspective of possible application to digital cameras is anticipated. The lenses described in the aforementioned patent documents have a shortcoming, for example, in compatibility between image forming performance and compactness. Japanese Unexamined Patent Publication No. 2007-017984 discloses various types of four-element image pickup lenses, but it is hard to say that optimization conditions have been studied for each configuration example. Note that the present invention is a utilization invention of the invention described in Japanese Unexamined Patent Publication No. 2009-020182. As a result of further consideration of the balance between downsizing and performance for the image pickup lens described in Japanese Unexamined Patent Publication No. 2009-020182, the object of the present invention has been solved.

The present invention has been developed in view of the problems described above, and it is an object of the present invention to provide an image pickup lens reduced in overall length with enhanced image forming performance.

### SUMMARY OF THE INVENTION

An image pickup lens of the present invention includes the following from an object side in the order listed below: a first lens having a positive refractive power; a second lens having a negative refractive power; a third lens having a positive refractive power; and a fourth lens having an object side surface which is concave or flat adjacent to an optical axis of the lens and a negative refractive power adjacent to the optical axis. The image pickup lens satisfies Conditional Expression (1) given below in which R3 is a paraxial radius of curvature of an object side surface of the second lens, and R4 is a paraxial radius of curvature of an image side surface of the second lens.

0.3<|(R4+R3)/(R4−R3)|<1.5 (1)

The image pickup lens of the present invention may provide advantageous effects for total length reduction and high image forming performance by optimizing the structure of each lens in a lens configuration of four lenses in total. In particular, the image pickup lens satisfies Conditional Expression (1) whereby the structure of the second lens is optimized. The image pickup lens of the present invention is advantageously configured for reducing a total length and obtaining high image forming performance even though the object side surface of the most image side lens (fourth lens) has a flat or concave shape adjacent to the optical axis. Then, by employing the following preferable configurations as appropriate, the total length reduction and performance enhancement may be facilitated.

0.3<|f4/f|<0.80 (2)

0.4<f1/f<1.1 (3)

0.2<f3/f<1.6 (4)

0.5<|f2/f|<2.0 (5)

20<ν1−ν2 (6)

where, f is an overall focal length, f1 is a focal length of the first lens, f2 is a focal length of the second lens, f3 is a focal length of the third lens, and f4 is a focal length of the fourth lens, ν1 is an Abbe number of the first lens with respect to d-line, and ν2 is an Abbe number of the second lens with respect to d-line.

Preferably, the image pickup lens of the present invention includes an aperture disposed on the object side of a surface apex position of an image side surface of the first lens on the optical axis.

Preferably, in the image pickup lens of the present invention, each of the first, second, third, and fourth lenses has an aspherical shape on each side.

In the image pickup lens of the present invention, it is particularly preferable that the image side surface of the fourth lens has a concave shape adjacent to the optical axis and a region in which the negative refractive power becomes weak toward the periphery in comparison with a region adjacent to the optical axis.

An image pickup apparatus of the present invention is an apparatus, including the image pickup lens of the present invention and an image sensor for outputting an imaging signal according to an optical image formed by the image pickup lens.

A portable terminal device of the present invention is a device, including the image pickup apparatus of the present invention and a display unit for displaying an image taken by the image pickup apparatus.

The image pickup apparatus or the portable terminal device of the present invention may obtain a high resolution imaging signal based on a high resolution optical image obtained by the image pickup lens of the present invention.

The image pickup lens of the present invention may realize total length reduction and high image forming performance by optimizing the shape and the like of each lens in a lens configuration of four lenses in total.

The image pickup apparatus or the portable terminal device of the present invention outputs an imaging signal according to an optical image formed by the image pickup lens of the present invention having high image forming performance, so that the apparatus or the device may obtain a high resolution image.

### BRIEF DESCRIPTION OF THE DRAWINGS

FIG. 1 is a first example configuration of an image pickup lens according to an embodiment of the present invention, which corresponds to a cross-sectional view of Numerical Example 1.

FIG. 2 is a second example configuration of the image pickup lens, which corresponds to a cross-sectional view of Numerical Example 2.

FIG. 3 is a third example configuration of the image pickup lens, which corresponds to a cross-sectional view of Numerical Example 3.

FIG. 4 is a fourth example configuration of the image pickup lens, which corresponds to a cross-sectional view of Numerical Example 4.

FIG. 5 is a fifth example configuration of an image pickup lens according to an embodiment of the present invention, which corresponds to a cross-sectional view of Numerical Example 5.

FIG. 6 is a sixth example configuration of the image pickup lens, which corresponds to a cross-sectional view of Numerical Example 6.

FIG. 7 is a seventh example configuration of the image pickup lens, which corresponds to a cross-sectional view of Numerical Example 7.

FIG. 8 is an eighth example configuration of the image pickup lens, which corresponds to a cross-sectional view of Numerical Example 8.

FIG. 9 is a ninth example configuration of the image pickup lens, which corresponds to a cross-sectional view of Numerical Example 9.

FIG. 10 is a tenth example configuration of the image pickup lens, which corresponds to a cross-sectional view of Numerical Example 10.

FIG. 11 is an eleventh example configuration of the image pickup lens, which corresponds to a cross-sectional view of Numerical Example 11.

FIG. 12A illustrates spherical aberration of Example 1.

FIG. 12B illustrates astigmatism of Example 1.

FIG. 12C illustrates distortion of Example 1.

FIG. 13A illustrates spherical aberration of Example 2.

FIG. 13B illustrates astigmatism of Example 2.

FIG. 13C illustrates distortion of Example 2.

FIG. 14A illustrates spherical aberration of Example 3.

FIG. 14B illustrates astigmatism of Example 3.

FIG. 14C illustrates distortion of Example 3.

FIG. 15A illustrates spherical aberration of Example 4.

FIG. 15B illustrates astigmatism of Example 4.

FIG. 15C illustrates distortion of Example 4.

FIG. 16A illustrates spherical aberration of Example 5.

FIG. 16B illustrates astigmatism of Example 5.

FIG. 16C illustrates distortion of Example 5.

FIG. 17A illustrates spherical aberration of Example 6.

FIG. 17B illustrates astigmatism of Example 6.

FIG. 17C illustrates distortion of Example 6.

FIG. 18A illustrates spherical aberration of Example 7.

FIG. 18B illustrates astigmatism of Example 7.

FIG. 18C illustrates distortion of Example 7.

FIG. 19A illustrates spherical aberration of Example 8.

FIG. 19B illustrates astigmatism of Example 8.

FIG. 19C illustrates distortion of Example 8.

FIG. 20A illustrates spherical aberration of Example 9.

FIG. 20B illustrates astigmatism of Example 9.

FIG. 20C illustrates distortion of Example 9.

FIG. 21A illustrates spherical aberration of Example 10.

FIG. 21B illustrates astigmatism of Example 10.

FIG. 21C illustrates distortion of Example 10.

FIG. 22A illustrates spherical aberration of Example 11.

FIG. 22B illustrates astigmatism of Example 11.

FIG. 22C illustrates distortion of Example 11.

FIG. 23 is a perspective view of a camera module, as an image pickup apparatus according to an embodiment of the present invention, illustrating an example structure thereof.

FIG. 24A is an external view of a camera-equipped cell phone, as a portable terminal device according to an embodiment of the present invention, illustrating an example structure thereof.

FIG. 24B is an external view of a camera-equipped cell phone, as a portable terminal device according to an embodiment of the present invention, illustrating an example structure thereof.

### DESCRIPTION OF THE PREFERRED EMBODIMENTS

### [Lens Configuration]

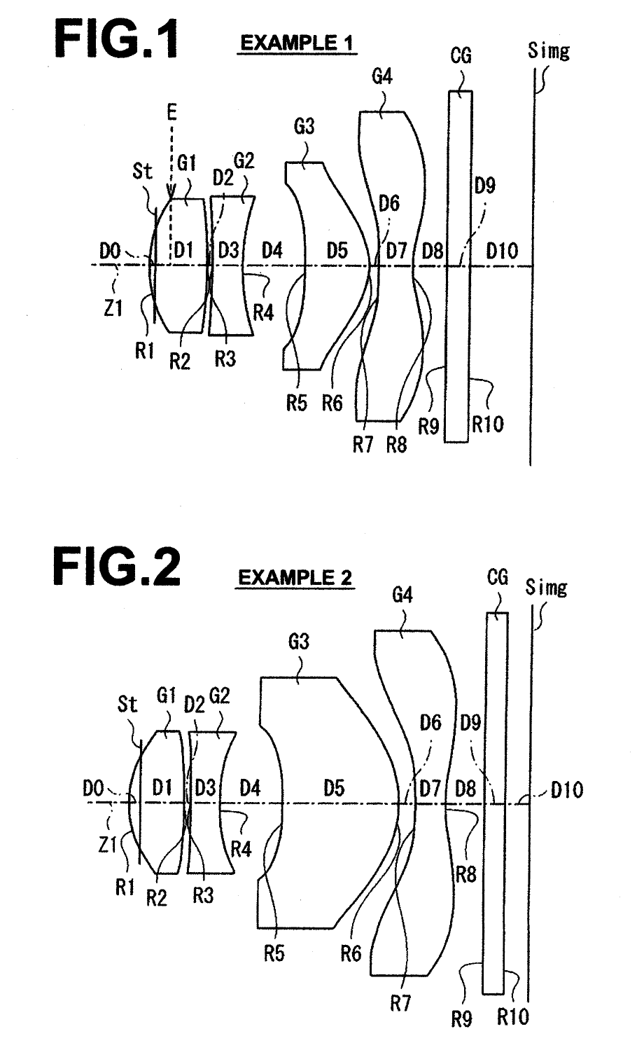

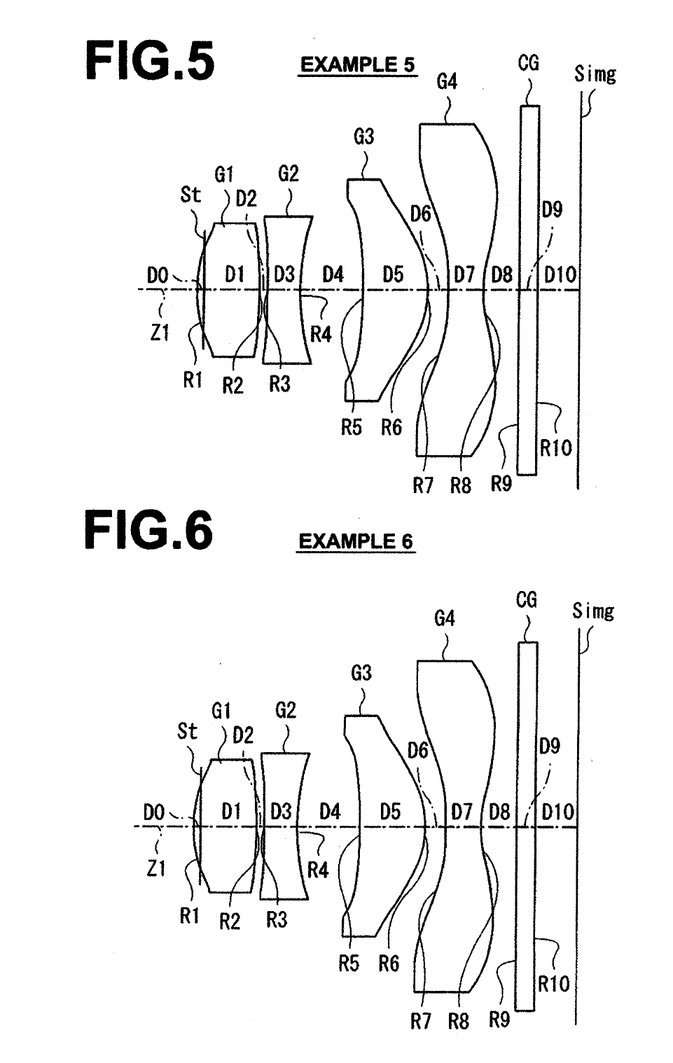

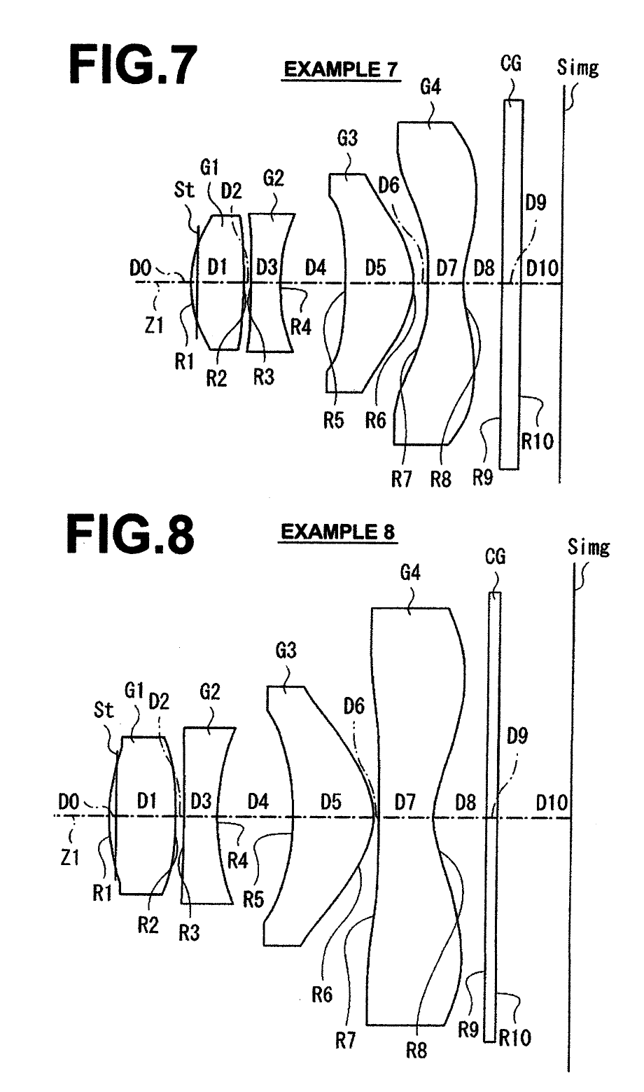

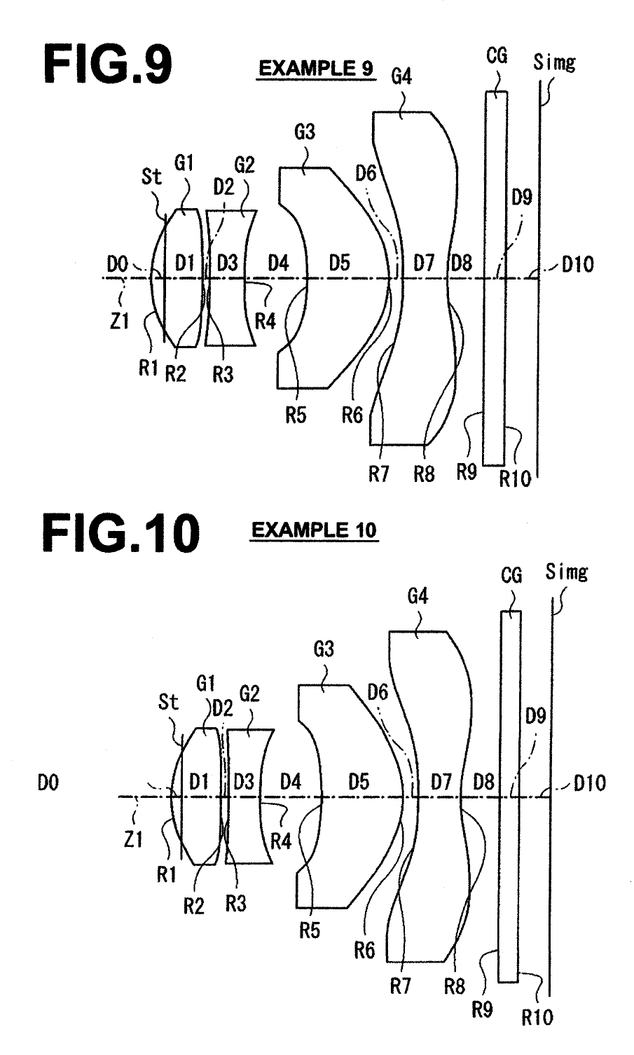

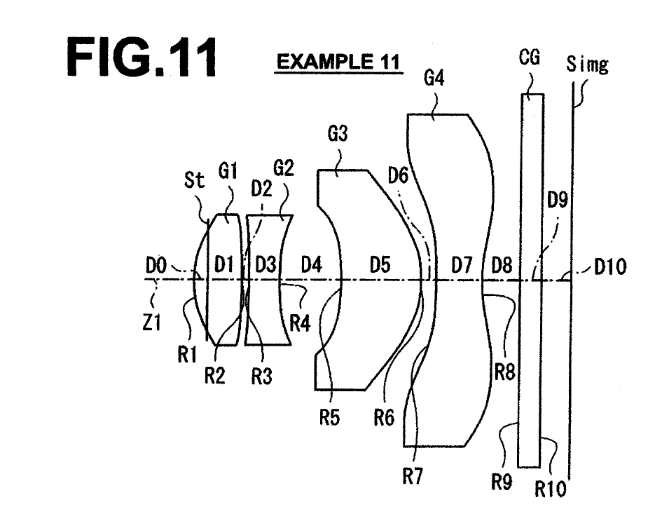

Hereinafter, embodiments of the present invention will be described in detail with reference to the accompanying drawings. FIG. 1 is a first example configuration of an image pickup lens according to an embodiment of the present invention. This example configuration corresponds to a lens configuration of First Numerical Example, to be described later. Likewise, second to eleventh example configurations corresponding to Second Numerical Example to Eleventh Numerical Example respectively are shown in FIGS. 2 to 11. In FIGS. 1 to 11, the symbol Ri represents a radius of curvature of an i^{th} surface, the surface number being gradually incremented toward image side (image plane side) with the surface of the lens element disposed on the most object side being taken as the first surface (aperture St being taken as zero^{th} surface). Symbol Di represents a surface separation between i^{th} surface and i^{th}+1 surface on optical axis Z1.

The image pickup lens according to the present embodiment includes from the object side in the order of aperture St, first lens G1, second lens G2, third lens G3, and fourth lens G4 along optical axis Z1.

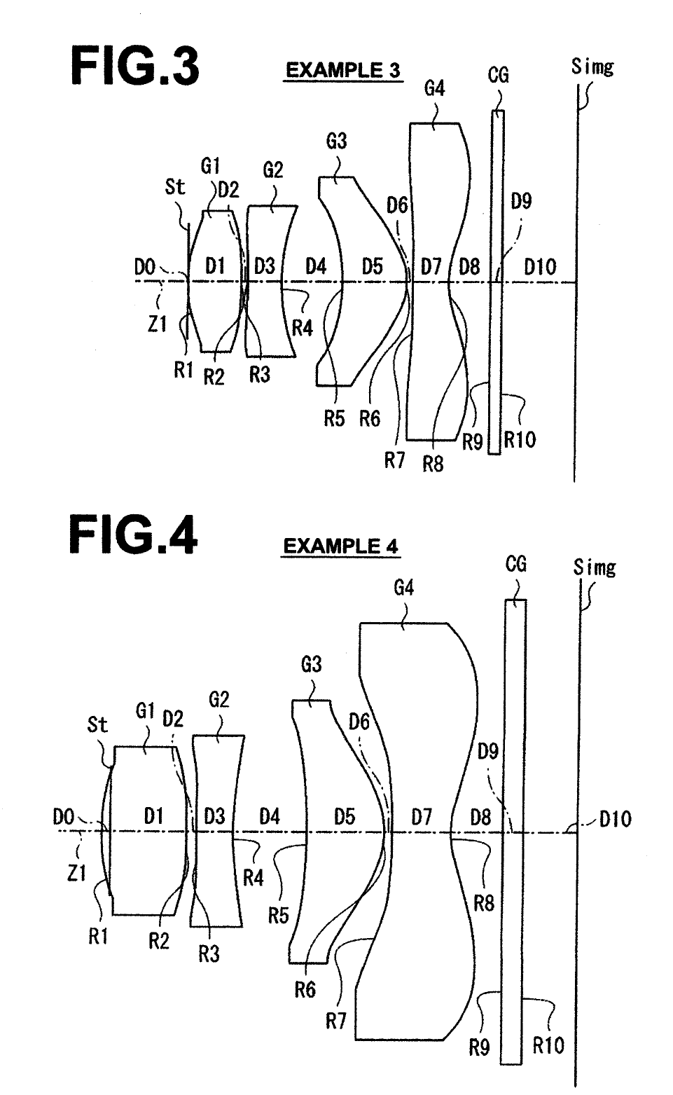

Aperture St is an optical aperture stop which is preferable to be disposed on the object side of the surface apex of the image side surface of lens G1 on optical axis Z1, thereby being disposed on the most object side of the lens system. Here, the term “most object side” as used herein includes not only the case in which aperture St is disposed at the surface apex position of the object side surface of first lens G1 as, for example, in the configuration shown in FIG. 3 but also the case in which aperture St is disposed between the surface apex position of the object side surface of first lens G1 and the surface apex position of the image side surface of first lens G1 as in other configurations. It is more preferable that aperture St is disposed at a position on optical axis Z1 further object side, for example, between the surface apex position of the object side surface of first lens G1 and edge position E (FIG. 1) of the object side surface of first lens G1.

Image plane Simg includes an image sensor, such as a CCD or the like. Various types of optical members CG may be disposed between fourth lens G4 and the image sensor according to the camera side structure on which the lens is mounted. For example, flat plate optical members, such as a cover glass for protecting the image plane and an infrared cut filter, may be disposed. In this case, for example, a flat plate cover glass with a coating having a filter effect, such as infrared cut filter, ND filter, or the like, applied thereon may be used as optical member CG. In the image pickup lens, all of lenses G1 to G4 or at least one lens surface may have a coating having a filter effect, such as infrared cut filter, ND filter, or the like, or an anti-reflection coating.

First lens G1 has a positive refractive power. Preferably, first lens G1 has a biconvex shape adjacent to the optical axis.

Second lens G2 has a negative refractive power. Second lens G2 may be a lens having, adjacent to the optical axis, a biconcave shape (e.g., example configuration in FIG. 1), a plano-concave shape with a flat surface on the object side (e.g., example configuration in FIG. 3), a meniscus shape with a convex surface toward the object side (e.g., example configuration in FIG. 4), or the like.

Third lens G3 has an image side surface which is convex adjacent to the optical axis and a positive refractive power. For example, an object side surface of third lens G3 is concave adjacent to the optical axis.

Fourth lens G4 has an object side surface which is concave (e.g., example configures shown in FIGS. 1 and 2) or flat (e.g., example configures shown in FIGS. 3 and 4) adjacent to an optical axis of the lens and has a negative refractive power adjacent to the optical axis.

Preferably, in each of first lens G1, second lens G2, third lens G3, and fourth lens G4, at least one surface is aspherical. The image side surface of fourth lens G4, in particular, has a concave shape adjacent to the optical axis and a region in which the negative refractive power becomes weak toward the periphery in comparison with a region adjacent to the optical axis. Further, it is preferable that the image side surface of fourth lens G4 has an aspherical shape having an inflexion point within an effective diameter. Still further, it is preferable that the image side surface of fourth lens G4 has an aspherical shape having a pole at a position other than the center of optical axis within the effective diameter. More specifically, it is preferable that, for example, the image side surface of fourth lens G4 is an aspherical surface having a concave shape toward the image side adjacent to the optical axis and a convex shape toward the image side in a peripheral region.

Here, if an aspherical shape is to be employed, second lens G2, third lens G3, and fourth lens G4 tend to have a complicated shape with a large size in comparison with first lens G1. Therefore, it is preferable that each of second lens G2, third lens G3, and fourth lens G4 is made of a resin material in view of workability and cost. Where manufacturing cost is important, it is preferable that first lens G1 is also made of a resin material, but first lens G1 may be made of a glass material in order to improve performance.

Preferably, the image pickup lens satisfies Conditional Expression (1) given below, in which R3 is a paraxial radius of curvature of the object side surface of second lens G2 and R4 is a paraxial radius of curvature of the image side surface of second lens G2.

0.3<|(R4+R3)/(R4−R3)|<1.5 (1)

Further, it is preferable that the image pickup lens selectively satisfies the following conditions as appropriate, in which f is an overall focal length, f1 is a focal length of first lens G1, f2 is a focal length of second lens G2, f3 is a focal length of third lens G3, and f4 is a focal length of fourth lens G4, ν1 is an Abbe number of first lens G1 with respect to d-line, and ν2 is an Abbe number of second lens G2 with respect to d-line.

0.3<|f4/f|<0.80 (2)

0.4<f1/f<1.1 (3)

0.2<f3/f<1.6 (4)

0.5<|f2/f|<2.0 (5)

20<ν1−ν2 (6)

### [Example Application to Image Pickup Apparatus]

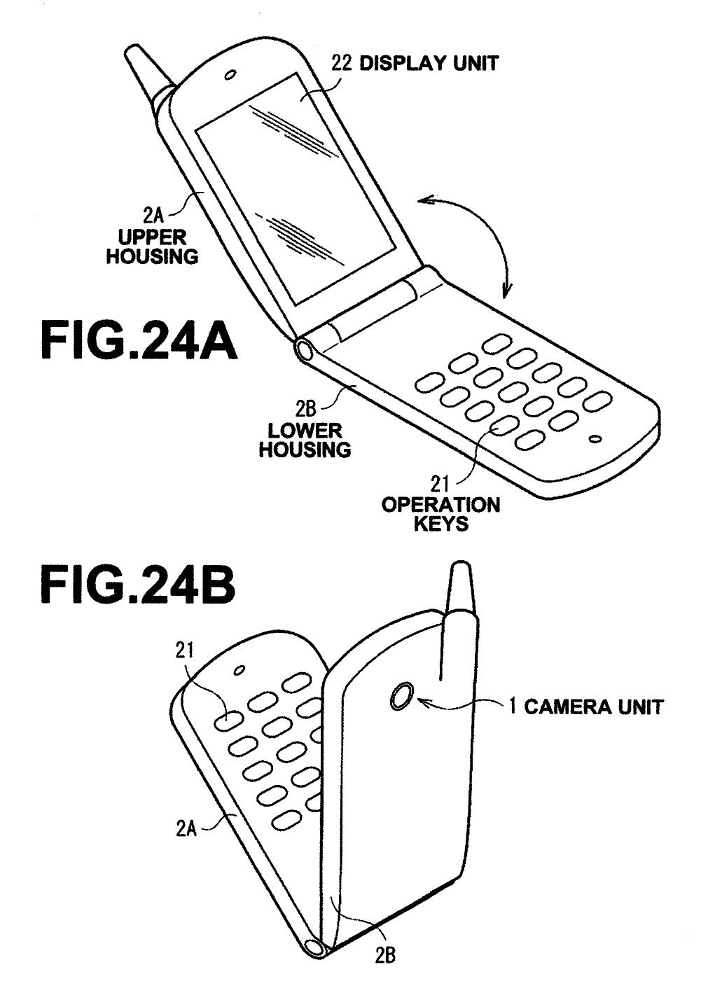

FIGS. 24A and 24B illustrate a camera-equipped cell phone, as an example of portable terminal device according to an embodiment. FIG. 23 illustrates an example structure of an image pickup apparatus according to an embodiment. The camera-equipped cell phone illustrated in FIGS. 24A and 24B includes upper housing 2A and lower housing 2B which are pivotable in the allow directions in FIG. 24A. Lower housing 2B includes operation keys 21 and the like. Upper housing 2A includes camera unit 1 (FIG. 24B), display unit (display means) 22 (FIG. 24A), and the like. Display unit 22 includes a display panel such as LCD (liquid crystal display), EL (electroluminescence) panel, or the like. Display unit 22 is disposed on a surface which becomes an inner side when the housings are folded together. Display unit 22 is capable of displaying an image obtained by camera unit 1 and the like, in addition to various menu items related to telephone function. Camera unit 1 is disposed, for example, on the rear side of upper housing 2A, but the place where camera unit 1 is provided is not limited to this.

Camera unit 1 includes, for example, a camera module shown in FIG. 23. The camera module includes a lens barrel 3 in which image pickup lens 20 is accommodated, support substrate 4 for supporting lens barrel 3, and an image sensor (not shown) provided at a position on support substrate 4 corresponding to the image plane of image pickup lens 20, as shown in FIG. 23. Camera unit 1 further includes flexible substrate 5 electrically connected to the image sensor provided on support substrate 4 and external connection terminal 6 electrically connected to flexible substrate 5 and structured to be connectable to a signal processing circuit provided on the cell phone body. These components are integrally constructed.

In camera unit 1, an optical image formed by image pickup lens 20 is converted to an electrical imaging signal by the image sensor and the imaging signal is outputted to the signal processing circuit provided on the apparatus body. The use of the image pickup lens of the present embodiment as image pickup lens 20 of such camera-equipped cell phone allows a sufficiently aberration corrected high resolution imaging signal to be obtained. Cell phone body may generate a high resolution image based on the imaging signal.

The image pickup lens of the present embodiment may be applied to various types of image pickup apparatuses and portable terminal devices that employ image sensors, such as CCD, CMOS, and the like. The image pickup apparatus or portable terminal device of the present embodiment is not limited to a camera-equipped cell phone and it may be, for example, a digital still camera, a PDA, or the like.

### [Operation and Advantageous Effects]

An operation and advantageous effects of the image pickup lens configured in the aforementioned manner will now be described. The image pickup lens according to the present embodiment may provide advantageous effects for total length reduction and high image forming performance by arranging the powers of the lenses from the object side in the order of positive, negative, positive, and negative, appropriately setting a surface shape of each lens, and satisfying a predetermined conditional expression in a lens configuration of four lenses in total. In particular, the image pickup lens is advantageously configured for reducing the total length and obtaining high image forming performance even though the object side surface of the most image side lens (fourth lens G4) has a flat or concave shape adjacent to the optical axis. Further, the negative refractive power of fourth lens G4 provides an advantageous effect of ensuring a sufficient back focus. If positive refractive power of fourth lens G4 is too strong, it is difficult to ensure a sufficient back focus.

Further, in the image pickup lens, the use of an aspherical surface for at least one surface of each of first lens G1, second lens G2, third lens G3, and fourth lens G4 provides an advantageous effect for maintaining aberration performance. In fourth lens G4, in particular, the light flux is separated with respect to each angle of view in comparison with first lens G1, second lens G2, and third lens G3. By making the image side surface of fourth lens G4, which is the lens surface closest to the image sensor, concave toward the image side adjacent to the optical axis and convex toward image side in a peripheral portion, aberration with respect to each angle of view is corrected appropriately and the incident angle of the light flux on the image sensor is controlled below a predetermined angle. This may reduce the unevenness in light amount over the entire region of the image plane and provide an advantageous effect for correcting curvature of field, distortion, and the like.

Generally, it is preferable that image pickup lens systems have telecentricity, that is, it is preferable that the incident angle of the chief ray becomes substantially parallel to the optical axis (incident angle on the image plane becomes close to zero with respect to normal line). In order to ensure the telecentricity, it is preferable that aperture St is disposed at a position as close to the object side as possible. On the other hand, if aperture St is disposed at a position further away from the object side surface of first lens G1 in the object side direction, the distance between aperture St and the object side surface of first lens G1 is added to the optical path, which is disadvantageous for downsizing the overall configuration. Consequently, telecentricity may be ensured while reducing the total length by disposing aperture St at a position on optical axis Z1 corresponding to the surface apex position of the object side surface of first lens G1 or a position on optical axis Z1 between the surface apex position of the object side surface of first lens G1 and the surface apex position of the image side surface of first lens G1. Where the telecentricity is more important, aperture St may be disposed at a position on optical axis Z1 between the surface apex position of the object side surface of first lens G1 and edge position E (FIG. 1) of the object side surface of first lens G1.

Conditional Expression (1) given above is related to the shape and refractive power of second lens G2. If |(R4+R3)/(R4−R3)| exceeds the upper limit of Conditional Expression (1), the refractive power of second lens becomes too weak, causing a disadvantageous effect for the total length reduction. While if |(R4+R3)/(R4−R3)| exceeds the lower limit of Conditional Expression (1), the refractive power of second lens becomes too strong, causing difficulty in aberration correction. In order to reduce the total length and to obtain high image forming performance, it is preferable that the numerical range of Conditional Expression (1) is as follows.

0.35<|(R4+R3)/(R4−R3)|<1.45 (1-1)

In order to obtain still better performance, it is preferable that |(R4+R3)/(R4−R3)| is in the following range.

0.6<|(R4+R3)/(R4−R3)|<1.1 (1-2)

Conditional Expression (2) given above is related to focal length f4 of fourth lens G4, and if |f4/f| exceeds upper limit of Conditional Expression (2) and the refractive power of fourth lens G4 becomes weak, it is difficult to reduce the total length. On the other hand, if |f4/f| exceeds lower limit of Conditional Expression (2), the refractive power of fourth lens G4 becomes strong and it is necessary to cancel out the increased refractive power of fourth lens G4 by increasing the refractive power of third lens G3, thereby causing degradation in off-axis performance. In order to obtain better performance, it is preferable that the numerical range of Conditional Expression (2) is as follows.

0.35<|f4/f|<0.70 (2-1)

In order to obtain still better performance, it is preferable that |f4/f| is in the following range.

0.4<|f4/f|<0.70 (2-2)

Conditional Expression (3) given above is related to focal length f1 of first lens G1, and if f1/f falls below the numerical range, the refractive power of first lens G1 becomes too strong, causing increase in spherical aberration, and it is difficult to ensure sufficient back focus. On the other hand, if f1/f exceeds the numerical range, it is difficult to reduce the total length and to correct curvature of field, astigmatism, and the like. In order to obtain better performance, it is preferable that the numerical range of Conditional Expression (3) is as follows.

0.45<f1/f<1.0 (3-1)

In order to obtain still better performance, it is preferable that f1/f is in the following range.

0.5<f1/f<0.9 (3-2)

Conditional Expression (4) given above is related to focal length f3 of third lens G3, and if f3/f falls below the numerical range and the positive refractive power of third lens G3 becomes too strong, the performance is degraded in addition to difficulty to ensure back focus. On the other hand, if f3/f exceeds the numerical range, the positive refractive power of third lens G3 becomes too weak, causing difficulty in aberration correction. In order to obtain better performance, it is preferable that the numerical range of Conditional Expression (4) is as follows.

0.3<f3/f<1.5 (4-1)

In order to obtain still better performance, it is preferable that f3/f is in the following range.

0.35<f3/f<1.1 (4-2)

Conditional Expression (5) given above is related to focal length f2 of second lens G2, and if f2/f falls below the numerical range, the positive refractive power of second lens G2 becomes too strong, resulting in increased aberration. On the other hand, if f2/f exceeds the numerical range, the refractive power of second lens G2 becomes too weak, causing difficulty in correcting curvature of field, astigmatism, and the like. In order to obtain better performance, it is preferable that the numerical range of Conditional Expression (5) is as follows.

0.8<f2/f<1.9 (5-1)

In order to obtain still better performance, it is preferable that f2/f is in the following range.

0.9<f2/f<1.8 (5-2)

Conditional Expression (5) given above defines dispersions of first lens G1 and second lens G2 and if the numerical range is satisfied by the first lens G1 and second lens G2, on-axis chromatic aberration may be reduced. In order to obtain better performance, it is preferable that the numerical range of Conditional Expression (6) is as follows.

25<ν1−ν2<40 (6-1)

In order to obtain still better performance, it is preferable that ν1−ν2 is in the following range.

28<ν1−ν2<32 (6-2)

As described above, according to the image pickup lens of the present embodiment, the total length reduction and high image forming performance may be realized. Further, according to the image pickup apparatus or portable terminal device of the present embodiment, an imaging signal is outputted according to an optical image formed by the image pickup lens reduced in the total length and enhanced in image forming performance, so that downsizing of the apparatus or device as a whole may be realized. Further, a high resolution imaging signal may be obtained and a high resolution image may be obtained based on the imaging signal.

### EXAMPLES

Specific Numerical Examples of the image pickup lens of the present invention will now be described. Hereinafter, a plurality of Numerical Examples is collectively described part by part.

### Numerical Example 1

[Table 1] and [Table 2] show specific lens data corresponding to the configuration of image pickup lens in FIG. 1. More specifically, [Table 1] shows basic lens data of the image pickup lens and [Table 2] shows aspherical surface data. In the lens data shown in [Table 1], surface number column Si represents i^{th} surface number (i=1 to 10) of the image pickup lens according to Example 1, which is gradually incremented toward image side with the surface of the component disposed on the most object side being taken as the first surface. The radius of curvature column Ri represents a radius of curvature (mm) of i^{th} surface from the object side corresponding to symbol Ri in FIG. 1. Likewise, surface separation column Di represents a surface separation (mm) on the optical axis between i^{th} surface Si and i^{th}+1 surface Si+1 from the object side. Ndj and νdj columns represent a refractive index and an Abbe number of j^{th} optical element from the object side with respect to d-line (wavelength of 587.6 nm) respectively. The focal length f (mm) and F-number (Mo.) of the entire system are given in the bottom margin of [Table 1].

In the image pickup lens according to Example 1, each of first lens G1 to fourth lens G4 has an aspherical shape on each side. In the basic data of [Table 1], values of radii of curvature adjacent to the optical axis are shown as the radii of curvature of the aspherical surfaces.

[Table 2] shows aspherical surface data of the image pickup lens according to Example 1. In the values shown as aspherical surface data, the symbol “E” indicates that the numerical value that follows is power to base 10, and the value preceding the symbol is multiplied by the value represented by the exponential function to base 10. For example, 1.0E-02 refers to 1.0×10⁻².

As for the aspherical surface data, values of each of coefficients Ai and K in Formula (A) given below which represents an aspherical surface shape. More specifically, Z represents a length of a perpendicular line (mm) drawn from a point on an aspherical surface at a height of h from the optical axis to the tangent plane (a plane perpendicular to the optical axis) to the apex of the aspherical surface.

Z=C·h²/{1+(1−K·C²·h²)^{1/2}}+ΣAᵢ·hⁱ (A)

where:
Z: depth of aspherical surface (mm)
H: distance (height) from optical axis to lens surface (mm)
K: eccentricity
C: paraxial curvature 1/R

(R: paraxial radius of curvature)

ΣAᵢ·hⁱ: sum of Aᵢ·hⁱ when i=3 to n (n: integer not less than 3)
Aᵢ: i^{th} order aspherical surface coefficient

In the Aspherical Surfaces of the Image Pickup Lens According to Example 1, aspherical surface coefficients Aₙ are indicated using A₃ to A₁₀ orders as effective based on Aspherical Surface Formula (A) given above.

TABLE 1
EXAMPLE 1 - BASIC LENS DATA

| Si | Ri | Di | Ndj | ν dj |
|---|---|---|---|---|
| (SURFACE NUMBER) | (RADIUS OF CURVATURE) | (SURFACE SEPARATION) | (REFRACTIVE INDEX) | (ABBE NUMBER) |
| 0 (APERTURE) | — | −0.090 | | |
| 1 | 1.758 | 0.814 | 1.510 | 56.4 |
| 2 | −20.328 | 0.101 | | |
| 3 | −860.761 | 0.422 | 1.614 | 25.3 |
| 4 | 3.388 | 0.898 | | |
| 5 | −4.753 | 0.897 | 1.534 | 55.9 |
| 6 | −1.123 | 0.160 | | |
| 7 | −6981.869 | 0.480 | 1.534 | 55.9 |
| 8 | 1.243 | 0.500 | | |
| 9 | ∞ | 0.300 | 1.516 | 64.1 |
| 10 | ∞ | 0.913 | | |

(f = 4.783 mm, FNo. = 2.80)

TABLE 2
EXAMPLE 1 - ASPHERICAL SURFACE DATA

| ASPHERICAL | | | | |
|---|---|---|---|---|
| COEFFICIENT | SURFACE NUMBER | | | |
| | FIRST SURFACE | SECOND SURFACE | THIRD SURFACE | FOURTH SURFACE |
| K | 1.5560279E−01 | 9.9000000E+01 | 4.9411473E+01 | 8.2484969E+00 |
| A3 | 1.4006091E−03 | −6.3344780E−03 | 8.3496906E−04 | 2.7421297E−02 |
| A4 | 1.2919335E−02 | 1.6399660E−02 | −5.6334558E−02 | −1.3008674E−01 |
| A5 | 4.4607136E−02 | −8.4925214E−02 | −4.3910184E−02 | 1.3096689E−01 |
| A6 | −7.6991981E−02 | 3.6188034E−02 | 8.0027305E−02 | −1.0224366E−01 |
| A7 | 7.9418716E−02 | 8.9849993E−02 | −8.4758594E−02 | −1.8364227E−02 |
| A8 | −5.0750444E−02 | −1.2994902E−01 | −5.8939537E−02 | 3.2042819E−02 |
| A9 | 1.4598591E−02 | −5.8643919E−02 | 1.0198891E−01 | 3.0778632E−02 |
| A10 | 3.3969505E−03 | 1.1378698E−01 | 6.2328731E−03 | −1.9939603E−02 |
| | FIFTH SURFACE | SIXTH SURFACE | SEVENTH SURFACE | EIGHTH SURFACE |
| K | 1.0444832E+01 | −4.2951582E+00 | −5.0000000E+01 | −6.3125169E+00 |
| A3 | −1.1124877E−04 | −1.3413013E−01 | −1.9015210E−01 | −1.1110405E−01 |
| A4 | −4.2977161E−02 | −1.3627949E−02 | 6.0092302E−02 | 4.1658678E−02 |
| A5 | 2.1133309E−02 | 5.8205256E−02 | 1.7262849E−02 | −6.6316595E−02 |
| A6 | 1.2934127E−02 | −6.1194586E−03 | −3.4960126E−02 | 8.5990670E−02 |
| A7 | −2.8953123E−02 | −6.1664359E−03 | 4.7360328E−02 | −6.4219868E−02 |
| A8 | 3.6946028E−04 | −1.9987615E−04 | −2.5032549E−02 | 2.9015923E−02 |
| A9 | 2.5337876E−02 | 3.1833385E−03 | 4.8934747E−03 | −7.6411918E−03 |
| A10 | −2.0003654E−02 | −3.6890083E−04 | −2.1239777E−04 | 8.9655367E−04 |

### Numerical Examples 2 to 11

As in Numerical Example 1 described above, specific lens data corresponding to the configuration of image pickup lens in FIG. 2 are shown in [Table 3] and [Table 4] as Numerical Example 2. Likewise, specific lens data corresponding to the configurations of image pickup lenses in FIGS. 3 to 11 are shown in [Table 5] to [Table 22]. As in Numerical Example 1, each of first lens G1 to fourth lens G4 has an aspherical shape on each side in Examples 2 to 11.

TABLE 3
EXAMPLE 2 - BASIC LENS DATA

| Si | Ri | Di | Ndj | ν dj |
|---|---|---|---|---|
| (SURFACE NUMBER) | (RADIUS OF CURVATURE) | (SURFACE SEPARATION) | (REFRACTIVE INDEX) | (ABBE NUMBER) |
| 0 (APERTURE) | — | −0.150 | | |
| 1 | 1.563 | 0.763 | 1.510 | 56.4 |
| 2 | −11.305 | 0.100 | | |
| 3 | −20.228 | 0.426 | 1.614 | 25.3 |
| 4 | 3.578 | 0.877 | | |
| 5 | −4.441 | 1.671 | 1.533 | 55.9 |
| 6 | −1.664 | 0.225 | | |
| 7 | −18.493 | 0.430 | 1.533 | 55.9 |
| 8 | 1.778 | 0.555 | | |
| 9 | ∞ | 0.300 | 1.516 | 64.1 |
| 10 | ∞ | 0.359 | | |

(f = 5.141 mm, FNo. = 2.80)

TABLE 4
EXAMPLE 2 - ASPHERICAL SURFACE DATA

| ASPHERICAL | | | | |
|---|---|---|---|---|
| COEFFICIENT | SURFACE NUMBER | | | |
| | FIRST SURFACE | SECOND SURFACE | THIRD SURFACE | FOURTH SURFACE |
| K | 1.5996465E−01 | 9.9000000E+01 | 4.9411473E+01 | 1.1441175E+01 |
| A3 | 4.2229604E−03 | −7.3914037E−03 | 1.0059805E−02 | 3.2694439E−02 |
| A4 | 1.0286901E−02 | 6.6794714E−02 | −1.9900871E−03 | −9.7492226E−02 |
| A5 | 4.8202200E−02 | −8.6666061E−02 | −2.7733951E−02 | 1.5276969E−01 |
| A6 | −7.9312063E−02 | 1.6120546E−02 | 9.7016131E−02 | −8.9379599E−02 |
| A7 | 7.9361706E−02 | 9.3506146E−02 | −9.3376411E−02 | −2.2610461E−02 |
| A8 | −3.4585755E−02 | −1.1120472E−01 | −8.2965345E−02 | 1.4411805E−02 |
| A9 | 2.0877393E−02 | −4.4117538E−02 | 8.0664468E−02 | 1.8149032E−02 |
| A10 | −2.3371669E−02 | 5.9704007E−02 | 1.0548933E−02 | 8.8419303E−03 |
| | FIFTH SURFACE | SIXTH SURFACE | SEVENTH SURFACE | EIGHTH SURFACE |
| K | 9.6863737E+00 | −9.6054504E+00 | −5.0000000E+01 | −6.9677677E+00 |
| A3 | 2.0990431E−03 | −1.7589161E−01 | −2.0609071E−01 | −9.1364109E−02 |
| A4 | −7.3613230E−02 | 1.0416148E−02 | 5.9220819E−02 | 4.2204266E−02 |
| A5 | 2.9038050E−02 | 5.2832322E−02 | 3.5254296E−03 | −6.5230279E−02 |
| A6 | 5.7159633E−04 | −1.1407399E−02 | −1.2707685E−02 | 7.6085305E−02 |
| A7 | −3.9007016E−02 | −8.5289480E−03 | 2.6702025E−02 | −5.2553636E−02 |
| A8 | −4.2201780E−04 | −1.0885309E−03 | −1.4010647E−02 | 2.1405985E−02 |
| A9 | 2.7583263E−02 | 2.8973866E−03 | 1.8803974E−03 | −4.8363964E−03 |
| A10 | −2.3804516E−02 | −3.4154152E−04 | 1.2369818E−04 | 4.6618841E−04 |

TABLE 5
EXAMPLE 3 - BASIC LENS DATA

| Si | Ri | Di | Ndj | ν dj |
|---|---|---|---|---|
| (SURFACE NUMBER) | (RADIUS OF CURVATURE) | (SURFACE SEPARATION) | (REFRACTIVE INDEX) | (ABBE NUMBER) |
| 0 (aperture) | — | 0.000 | | |
| 1 | 2.123 | 0.741 | 1.510 | 56.4 |
| 2 | −5.081 | 0.091 | | |
| 3 | ∞ | 0.498 | 1.614 | 25.3 |
| 4 | 2.968 | 0.859 | | |
| 5 | −2.785 | 0.923 | 1.534 | 55.9 |
| 6 | −0.841 | 0.100 | | |
| 7 | ∞ | 0.514 | 1.534 | 55.9 |
| 8 | 1.024 | 0.600 | | |
| 9 | ∞ | 0.145 | 1.516 | 64.1 |
| 10 | ∞ | 1.077 | | |

(f = 4.604 mm, FNo. = 2.80)

TABLE 6
EXAMPLE 3 - ASPHERICAL SURFACE DATA

| ASPHERICAL | | | | |
|---|---|---|---|---|
| COEFFICIENT | SURFACE NUMBER | | | |
| | FIRST SURFACE | SECOND SURFACE | THIRD SURFACE | FOURTH SURFACE |
| K | 1.3270583E+00 | 2.8394125E+00 | 0.0000000E+00 | −1.5835652E+00 |
| A3 | −1.1923024E−03 | −5.9562351E−03 | −4.7579952E−03 | 3.1651936E−02 |
| A4 | 4.7735940E−04 | 8.4626913E−02 | 3.0310761E−02 | −9.2713812E−02 |
| A5 | −5.4575110E−02 | −5.4451891E−01 | −7.9170079E−02 | 1.7622095E−01 |
| A6 | 3.3403836E−02 | 1.9828213E+00 | 6.4555327E−02 | −1.1195113E−01 |
| A7 | 2.3156143E−02 | −4.5021929E+00 | −9.4415006E−02 | −6.1381107E−02 |
| A8 | −3.0421426E−02 | 5.6602180E+00 | −4.3828856E−02 | 4.8231545E−02 |
| A9 | −5.8980843E−02 | −3.7458343E+00 | 1.9651004E−01 | 5.0331246E−02 |
| A10 | 4.0712127E−02 | 1.0328575E+00 | −7.6410632E−02 | −2.4905086E−02 |
| | FIFTH SURFACE | SIXTH SURFACE | SEVENTH SURFACE | EIGHTH SURFACE |
| K | 4.0000000E+00 | −3.0782342E+00 | −2.3785843E+01 | −6.9386518E+00 |
| A3 | 1.7074470E−02 | −6.6429944E−02 | −4.0134501E−02 | 2.2188831E−02 |
| A4 | −7.2163844E−02 | −9.2563982E−02 | 2.6382859E−02 | −1.2646538E−01 |
| A5 | 5.7731881E−02 | 7.8511702E−02 | −2.4959026E−02 | 7.7750178E−02 |
| A6 | 2.6211307E−02 | 1.3367967E−03 | 4.4333237E−03 | −1.3417203E−02 |
| A7 | −2.3425011E−02 | −6.7973234E−03 | 7.9789159E−03 | −4.9400181E−03 |
| A8 | −8.6562310E−03 | −1.5628306E−03 | −2.1798543E−03 | 1.0897761E−03 |
| A9 | 1.5282720E−02 | 2.5428674E−03 | −6.5454041E−04 | 6.2297402E−04 |
| A10 | −9.9229585E−03 | −2.2225608E−04 | 1.9698704E−04 | −1.6282602E−04 |

TABLE 7
EXAMPLE 4 - BASIC LENS DATA

| Si | Ri | Di | Ndj | ν dj |
|---|---|---|---|---|
| (SURFACE NUMBER) | (RADIUS OF CURVATURE) | (SURFACE SEPARATION) | (REFRACIVE INDEX) | (ABBE NUMBER) |
| 0 (APERTURE) | — | −0.100 | | |
| 1 | 3.088 | 1.223 | 1.510 | 55.9 |
| 2 | −7.354 | 0.121 | | |
| 3 | 25.493 | 0.517 | 1.614 | 25.3 |
| 4 | 4.605 | 1.078 | | |
| 5 | −7.253 | 1.100 | 1.510 | 55.9 |
| 6 | −1.258 | 0.120 | | |
| 7 | ∞ | 0.822 | 1.510 | 55.9 |
| 8 | 1.243 | 0.750 | | |
| 9 | ∞ | 0.300 | 1.516 | 64.1 |
| 10 | ∞ | 0.783 | | |

(f = 5.397 mm, FNo. = 2.80)

TABLE 8
EXAMPLE 4 - ASPHERICAL SURFACE DATA

| ASPHERICAL | | | | |
|---|---|---|---|---|
| COEFFICIENT | SURFACE NUMBER | | | |
| | FIRST SURFACE | SECOND SURFACE | THIRD SURFACE | FOURTH SURFACE |
| K | 8.0532787E−01 | −1.6560880E+01 | −1.6172179E+01 | −1.1660851E+01 |
| A3 | 1.0439704E−03 | −1.7958940E−02 | −2.0397325E−02 | 2.1546691E−02 |
| A4 | −3.8545872E−03 | −1.3589246E−03 | −9.3701929E−03 | −6.6170076E−02 |
| A5 | −5.6694480E−03 | −2.3693937E−02 | −2.3093583E−02 | 8.4645241E−02 |
| A6 | 2.8906642E−04 | 1.6276425E−04 | 2.4342386E−02 | −3.8863490E−02 |
| A7 | 2.9777704E−04 | 2.6760376E−03 | −2.4281501E−02 | −1.9380336E−02 |
| A8 | 8.1443196E−04 | 1.0587481E−03 | −1.0163367E−02 | 9.9846757E−03 |
| A9 | −2.3703254E−03 | −5.9207070E−04 | 3.1501033E−02 | 9.7697294E−03 |
| A10 | 6.5353882E−04 | 1.1017382E−03 | −1.0809722E−02 | −4.5259139E−03 |
| | FIFTH SURFACE | SIXTH SURFACE | SEVENTH SURFACE | EIGHTH SURFACE |
| K | 9.0954289E+00 | −4.6360454E+00 | 0.0000000E+00 | −5.4996972E+00 |
| A3 | 1.3147124E−02 | −9.7137158E−02 | −6.5439208E−02 | 1.4034823E−02 |
| A4 | −1.2733908E−02 | 7.4700389E−03 | 3.3057316E−03 | −6.5095121E−02 |
| A5 | −2.0977872E−03 | 1.6257085E−02 | −8.8924130E−03 | 3.1387878E−02 |
| A6 | 1.0002505E−02 | −3.0212189E−03 | 2.1652956E−03 | −4.3966718E−03 |
| A7 | −3.4857992E−03 | −8.0099914E−04 | 2.5232626E−03 | −1.3083820E−03 |
| A8 | −1.7247487E−03 | 4.6869399E−04 | −3.0065376E−04 | 2.4400123E−04 |
| A9 | 1.9996794E−03 | 6.0495263E−04 | −9.1201306E−05 | 1.0820181E−04 |
| A10 | −8.6564896E−04 | −9.3686708E−05 | −2.2600246E−06 | −2.6382625E−05 |

TABLE 9
EXAMPLE 5 - BASIC LENS DATA

| Si | Ri | Di | Ndj | ν dj |
|---|---|---|---|---|
| (SURFACE NUMBER) | (RADIUS OF CURVATURE) | (SURFACE SEPARATION) | (REFRACTIVE INDEX) | (ABBE NUMBER) |
| 0 (APERTURE) | — | −0.090 | | |
| 1 | 1.834 | 0.889 | 1.510 | 56.4 |
| 2 | −11.517 | 0.121 | | |
| 3 | −35.202 | 0.461 | 1.606 | 26.9 |
| 4 | 3.461 | 0.894 | | |
| 5 | −8.420 | 0.946 | 1.531 | 55.3 |
| 6 | −1.355 | 0.267 | | |
| 7 | −6923.634 | 0.499 | 1.531 | 55.3 |
| 8 | 1.301 | 0.500 | | |
| 9 | ∞ | 0.300 | 1.516 | 64.1 |
| 10 | ∞ | 0.588 | | |

(f = 4.700 mm, FNo. = 2.80)

TABLE 10
EXAMPLE 5 - ASPHERICAL SURFACE DATA

| ASPHERICAL | | | | |
|---|---|---|---|---|
| COEFFICIENT | SURFACE NUMBER | | | |
| | FIRST SURFACE | SECOND SURFACE | THIRD SURFACE | FOURTH SURFACE |
| K | −9.8055348B−02 | 9.9000000E+01 | 4.9411473E+01 | 7.6859273E+00 |
| A3 | 4.6986230B−03 | −2.7052792E−03 | 1.0923064E−02 | 3.8266559E−02 |
| A4 | −6.9473683E−05 | 3.0106787E−02 | −5.1379117E−02 | −1.2573900E−01 |
| A5 | 5.6663646E−02 | −7.5462467E−02 | −2.4039734E−02 | 1.4124725E−01 |
| A6 | −7.5633336E−02 | 3.8089624E−02 | 9.8584221E−02 | −9.2763388E−02 |
| A7 | 7.0048593E−02 | 8.9658450E−02 | −8.6846005E−02 | −1.7885910E−02 |
| A8 | −4.6741471E−02 | −1.3589144E−01 | −8.2085927E−02 | 2.6561265E−02 |
| A9 | 1.0836130E−02 | −3.1120253E−02 | 9.7981569E−02 | 2.2674289E−02 |
| A10 | 5.3109803E−03 | 8.1819634E−02 | −1.0666194E−03 | −1.5901100E−02 |
| | FIFTH SURFACE | SIXTH SURFACE | SEVENTH SURFACE | EIGHTH SURFACE |
| K | 7.6053089E+00 | −7.2396371E+00 | −5.0000000E+01 | −6.7382572E+00 |
| A3 | 9.7928376E−03 | −1.6294509E−01 | −2.0842963E−01 | −9.0788278E−02 |
| A4 | −4.8181820E−02 | −8.3173559E−04 | 6.1982944E−02 | 4.9936993E−02 |
| A5 | 1.7975933E−02 | 5.9388081E−02 | −5.2558500E−04 | −9.4953206E−02 |
| A6 | 1.7110551E−02 | −8.0115313E−03 | −3.5141645E−03 | 1.2175232E−01 |
| A7 | −2.8685385E−02 | −7.9670091E−03 | 1.7729937E−02 | −9.1769719E−02 |
| A8 | −5.1549411E−03 | −1.2722105E−03 | −8.5615832E−03 | 4.1298210E−02 |
| A9 | 2.1330294E−02 | 2.8701559E−03 | 2.0529308E−04 | −1.0409688E−02 |
| A10 | −1.1051382E−02 | −7.4939428E−05 | 3.0613299E−04 | 1.1225836E−03 |

TABLE 11
EXAMPLE 6 - BASIC LENS DATA

| Si | Ri | Di | Ndj | ν dj |
|---|---|---|---|---|
| (SURFACE NUMBER) | (RADIUS OF CURVATURE) | (SURFACE SEPARATION) | (REFRACTIVE INDEX) | (ABBE NUMBER) |
| 0 (APERTURE) | — | −0.090 | | |
| 1 | 1.825 | 0.889 | 1.510 | 56.4 |
| 2 | −11.656 | 0.119 | | |
| 3 | −26.233 | 0.464 | 1.606 | 26.9 |
| 4 | 3.567 | 0.894 | | |
| 5 | −8.476 | 0.946 | 1.531 | 55.3 |
| 6 | −1.356 | 0.268 | | |
| 7 | ∞ | 0.498 | 1.531 | 55.3 |
| 8 | 1.299 | 0.500 | | |
| 9 | ∞ | 0.300 | 1.516 | 64.1 |
| 10 | ∞ | 0.590 | | |

(f = 4.703 mm, FNo. = 2.80)

TABLE 12
EXAMPLE 6 - ASPHERICAL SURFACE DATA

| ASPHERICAL | | | | |
|---|---|---|---|---|
| COEFFICIENT | SURFACE NUMBER | | | |
| | FIRST SURFACE | SECOND SURFACE | THIRD SURFACE | FOURTH SURFACE |
| K | −6.1396360E−02 | 9.9000000E+01 | 4.9411473E+01 | 8.1889710E+00 |
| A3 | 4.6005202E−03 | −1.4431669E−03 | 1.1554108E−02 | 3.8837187E−02 |
| A4 | 6.7089154E−04 | 3.0348494E−02 | −4.9505855E−02 | −1.2547693E−01 |
| A5 | 5.6560630E−02 | −7.3554131E−02 | −2.3933217E−02 | 1.4103900E−01 |
| A6 | −7.5428696E−02 | 3.9437323E−02 | 9.8051579E−02 | −9.2433428E−02 |
| A7 | 7.0379178E−02 | 8.9368446E−02 | −8.6677080E−02 | −1.7515958E−02 |
| A8 | −4.6487144E−02 | −1.3706365E−01 | −8.1152011E−02 | 2.6603193E−02 |
| A9 | 1.1146567E−02 | −3.1603323E−02 | 9.8680724E−02 | 2.2487077E−02 |
| A10 | 5.8063010E−03 | 8.4391095E−02 | −1.7841708E−03 | −1.5998504E−02 |
| | FIFTH SURFACE | SIXTH SURFACE | SEVENTH SURFACE | EIGHTH SURFACE |
| K | 8.4201711E+00 | −7.2590988E+00 | −5.0000000E+01 | −6.7806055E+00 |
| A3 | 1.0354841E−02 | −1.6215385E−01 | −2.0794753E−01 | −8.9573001E−02 |
| A4 | −4.8393348E−02 | −7.2515989E−04 | 6.2173168E−02 | 4.4329073E−02 |
| A5 | 1.7912025E−02 | 5.9307981E−02 | −8.1160098E−04 | −8.0078953E−02 |
| A6 | 1.7050110E−02 | −8.0758135E−03 | −2.9583326E−03 | 1.0127672E−01 |
| A7 | −2.8753450E−02 | −7.9847387E−03 | 1.7118326E−02 | −7.5636150E−02 |
| A8 | −5.1808154E−03 | −1.2648116E−03 | −8.1801505E−03 | 3.3960500E−02 |
| A9 | 2.1345204E−02 | 2.8802477E−03 | 7.1687550E−05 | −8.6174930E−03 |
| A10 | −1.1055322E−02 | −7.2191982E−05 | 3.2527354E−04 | 9.4088282E−04 |

TABLE 13
EXAMPLE 7 - BASIC LENS DATA

| Si | Ri | Di | Ndj | ν dj |
|---|---|---|---|---|
| (SURFACE NUMBER) | (RADIUS OF CURVATURE) | (SURFACE SEPERATION) | (REFRACTIVE INDEX) | (ABBE NUMBER) |
| 0 (APERTURE) | — | −0.090 | | |
| 1 | 1.728 | 0.759 | 1.510 | 56.4 |
| 2 | −12.161 | 0.101 | | |
| 3 | −402.747 | 0.421 | 1.606 | 26.9 |
| 4 | 3.123 | 0.934 | | |
| 5 | −7.242 | 0.976 | 1.531 | 55.3 |
| 6 | −1.320 | 0.211 | | |
| 7 | ∞ | 0.501 | 1.531 | 55.3 |
| 8 | 1.275 | 0.550 | | |
| 9 | ∞ | 0.300 | 1.516 | 64.1 |
| 10 | ∞ | 0.573 | | |

(f = 4.654 mm, FNo. = 2.80)

TABLE 14
EXAMPLE 7 - ASPHERICAL SURFACE DATA

| ASPHERICAL | | | | |
|---|---|---|---|---|
| COEFFICIENT | SURFACE NUMBER | | | |
| | FIRST SURFACE | SECOND SURFACE | THIRD SURFACE | FOURTH SURFACE |
| K | −2.5008770E−01 | 9.9000000E+01 | 4.9411473E+01 | 7.2963985E+00 |
| A3 | 6.0574955E−03 | −1.6003056E−03 | 1.0443358E−02 | 3.3804627E−02 |
| A4 | 1.1198732E−03 | 3.5617664E−02 | −3.4374952E−02 | −1.0841682E−01 |
| A5 | 7.0127917E−02 | −7.0341177E−02 | −1.4737097E−02 | 1.3682747E−01 |
| A6 | −7.8486053E−02 | 3.0975778E−02 | 8.2768288E−02 | −1.0276038E−01 |
| A7 | 6.1507288E−02 | 7.4411421E−02 | −1.0812820E−01 | −1.8218185E−02 |
| A8 | −5.3758045E−02 | −1.4459307E−01 | −8.2350514E−02 | 3.1628865E−02 |
| A9 | 2.1717480E−02 | −5.1273861E−02 | 9.5705482E−02 | 2.7961211E−02 |
| A10 | 1.7268117E−03 | 1.1631727E−01 | 2.5301326E−02 | −1.9029159E−02 |
| | FIFTH SURFACE | SIXTH SURFACE | SEVENTH SURFACE | EIGHTH SURFACE |
| K | 1.0009887E+01 | −7.0461794E+00 | −5.0000000E+01 | −6.4802894E+00 |
| A3 | 8.3518160E−03 | −1.7567776E−01 | −2.1898333E−01 | −9.5411836E−02 |
| A4 | −5.2636430E−02 | 3.5747823E−03 | 6.2901381E−02 | 5.5756116E−02 |
| A5 | 1.9086669E−02 | 6.2609552E−02 | −8.1925060E−03 | −1.1941597E−01 |
| A6 | 2.0314066E−02 | −7.2873528E−03 | 1.1291928E−02 | 1.6242623E−01 |
| A7 | −2.7151587E−02 | −8.4884632E−03 | 3.1017473E−03 | −1.3067303E−01 |
| A8 | −6.5624786E−03 | −1.8681076E−03 | 1.5413309E−04 | 6.2761461E−02 |
| A9 | 1.8582254E−02 | 2.6648401E−03 | −2.3830398E−03 | −1.6703022E−02 |
| A10 | −1.0586639E−02 | 1.2104457E−04 | 5.9571962E−04 | 1.8805043E−03 |

TABLE 15
EXAMPLE 8 - BASIC LENS DATA

| Si | Ri | Di | Ndj | ν dj |
|---|---|---|---|---|
| (SURFACE NUMBER) | (RADIUS OF CURVATURE) | (SURFACE SEPARATION) | (REFRACTIVE INDEX) | (ABBE NUMBER) |
| 0 (APERTURE) | — | −0.100 | | |
| 1 | 2.754 | 0.950 | 1.510 | 55.9 |
| 2 | −4.988 | 0.120 | | |
| 3 | −10000.000 | 0.480 | 1.614 | 25.3 |
| 4 | 3.540 | 1.080 | | |
| 5 | −3.883 | 1.150 | 1.534 | 55.9 |
| 6 | −1.049 | 0.090 | | |
| 7 | −10000.000 | 0.780 | 1.534 | 55.9 |
| 8 | 1.211 | 0.750 | | |
| 9 | ∞ | 0.145 | 1.516 | 64.1 |
| 10 | ∞ | 1.081 | | |

(f = 5.305 mm, FNo. = 2.80)

TABLE 16
EXAMPLE 8 - ASPHERICAL SURFACE DATA

| ASPHERICAL | | | | |
|---|---|---|---|---|
| COEFFICIENT | SURFACE NUMBER | | | |
| | FIRST SURFACE | SECOND SURFACE | THIRD SURFACE | FOURTH SURFACE |
| K | 9.8438466E−01 | −6.5690402E+00 | 0.0000000E+00 | −1.5955141E+00 |
| A3 | 3.4946382E−04 | −4.9460334E−03 | −2.3242263E−03 | 2.4045477E−02 |
| A4 | −3.4574810E−03 | 3.8993342E−02 | 2.4061489E−02 | −4.8476071E−02 |
| A5 | −2.0619100E−02 | −1.9062393E−01 | −3.9826135E−02 | 7.2182292E−02 |
| A6 | 1.1381871E−02 | 5.2639240E−01 | 1.5873864E−02 | −3.8023956E−02 |
| A7 | 4.6541445E−03 | −1.0168398B+00 | −2.5858234E−02 | −1.6536335E−02 |
| A8 | −7.7405027E−03 | 1.0777009E+00 | −7.8294206E−03 | 1.0631056E−02 |
| A9 | −1.1225234E−02 | −5.9804505E−01 | 3.4448573E−02 | 9.0194098E−03 |
| A10 | 6.7574843E−03 | 1.3842895E−01 | −9.9248072E−03 | −3.5476687E−03 |
| | FIFTH SURFACE | SIXTH SURFACE | SEVENTH SURFACE | EIGHTH SURFACE |
| K | 5.0000000E+00 | −2.8056628E+00 | −2.3785843E+01 | −5.9551168E+00 |
| A3 | 9.5784846E−03 | −4.2207815E−02 | −1.7768662E−02 | 2.1009846E−02 |
| A4 | −2.3769397E−02 | −3.1979022E−02 | 7.8429270E−03 | −6.7602467E−02 |
| A5 | 1.4443901E−02 | 2.0428103E−02 | −1.0751881E−02 | 3.2934384E−02 |
| A6 | 6.7464045E−03 | −2.0421437E−03 | 1.5348001E−03 | −4.3469833E−03 |
| A7 | −5.3064813E−03 | −9.3631750E−04 | 2.1888281E−03 | −1.4019903E−03 |
| A8 | −9.2765641E−04 | 3.4178694E−04 | −4.2208522E−04 | 2.0595016E−04 |
| A9 | 2.9522338E−03 | 5.3884689E−04 | −1.0579684E−04 | 1.0575320E−04 |
| A10 | −1.3644161E−03 | −1.1844823E−04 | 2.1778224E−05 | −1.9561196E−05 |

TABLE 17
EXAMPLE 9 - BASIC LENS DATA

| Si | Ri | Di | Ndj | ν dj |
|---|---|---|---|---|
| (SURFACE NUMBER) | (RADIUS OF CURVATURE) | (SURFACE SEPARATION) | (REFRACTIVE INDEX) | (ABBE NUMBER) |
| 0 (APERTURE) | — | −0.200 | | |
| 1 | 1.526 | 0.729 | 1.510 | 56.4 |
| 2 | −10.794 | 0.099 | | |
| 3 | −9.493 | 0.504 | 1.614 | 25.3 |
| 4 | 4.422 | 0.905 | | |
| 5 | −2.865 | 1.159 | 1.534 | 55.9 |
| 6 | −1.617 | 0.208 | | |
| 7 | −793.260 | 0.626 | 1.534 | 55.9 |
| 8 | 1.839 | 0.550 | | |
| 9 | ∞ | 0.300 | 1.516 | 64.1 |
| 10 | ∞ | 0.465 | | |

(f = 5.139 mm, FNo. = 2.80)

TABLE 18
EXAMPLE 9 - ASPHERICAL SURFACE DATA

| ASPHERICAL | | | | |
|---|---|---|---|---|
| COEFFICIENT | SURFACE NUMBER | | | |
| | FIRST SURFACE | SECOND SURFACE | THIRD SURFACE | FOURTH SURFACE |
| K | 5.3436614E−01 | 9.9000000E+01 | 4.9411473E+01 | 1.8810761E+01 |
| A3 | −6.1431387E−03 | −1.6602929E−02 | 4.2514043E−03 | 3.0604639E−02 |
| A4 | 2.9198593E−02 | 8.6536545E−02 | 3.5656196E−02 | −7.5804502E−02 |
| A5 | 1.9677994E−02 | −8.8571241E−02 | −4.4212956E−02 | 1.5448591E−01 |
| A6 | −9.0730653E−02 | −6.2306192E−03 | 8.2735516E−02 | −9.9557878E−02 |
| A7 | 8.4549926E−02 | 8.3608117E−02 | −8.0483933E−02 | −2.3313158E−02 |
| A8 | −1.6516802E−02 | −9.1622693E−02 | −6.8794583E−02 | 2.4178877E−02 |
| A9 | 3.5415710E−02 | −1.5992297E−02 | 8.1881351E−02 | 1.9665161E−02 |
| A10 | −5.0740343E−02 | 3.0887158E−02 | 1.3938868E−03 | 7.3825547E−03 |
| | FIFTH SURFACE | SIXTH SURFACE | SEVENTH SURFACE | EIGHTH SURFACE |
| K | 5.1965368E+00 | −7.0040313E+00 | −5.0000000E+01 | −7.0137506E+00 |
| A3 | 1.3107369E−03 | −1.6512723E−01 | −2.0279692E−01 | −8.9347913E−02 |
| A4 | −6.2328723E−02 | −9.8441099E−03 | 6.9157013E−02 | 2.9444884E−02 |
| A5 | 7.8472854E−03 | 5.1077157E−02 | −1.2746145E−02 | −3.1298250E−02 |
| A6 | −9.8717822E−03 | −1.0476253E−02 | 1.9137937E−02 | 2.4321854E−02 |
| A7 | −3.3957439E−02 | −8.4943329E−03 | −8.2604741E−03 | −5.7771164E−03 |
| A8 | 1.2847845E−02 | −1.3330453E−03 | 7.8475979E−03 | −3.0477876E−03 |
| A9 | 3.4797858E−02 | 2.9138198E−03 | −5.7289653E−03 | 1.9980414E−03 |
| A10 | −4.2711878E−02 | 1.0915894E−06 | 1.1896081E−03 | −3.3082425E−04 |

TABLE 19
EXAMPLE 10 - BASIC LENS DATA

| Si | Ri | Di | Ndj | ν dj |
|---|---|---|---|---|
| (SURFACE NUMBER) | (RADIUS OF CURVATURE) | (SURFACE SEPARATION) | (REFRACTIVE INDEX) | (ABBE NUMBER) |
| 0 (APERTURE) | — | −0.15 | | |
| 1 | 1.553 | 0.710 | 1.510 | 56.4 |
| 2 | −10.660 | 0.101 | | |
| 3 | −15.400 | 0.455 | 1.614 | 25.3 |
| 4 | 3.743 | 0.882 | | |
| 5 | −3.718 | 1.156 | 1.534 | 55.9 |
| 6 | −1.644 | 0.222 | | |
| 7 | −1012.323 | 0.596 | 1.534 | 55.9 |
| 8 | 1.712 | 0.550 | | |
| 9 | ∞ | 0.300 | 1.516 | 64.1 |
| 10 | ∞ | 0.438 | | |

(f = 4.925 mm, FNo. = 2.80)

TABLE 20
EXAMPLE 10 - ASPHERICAL SURFACE DATA

| ASPHERICAL | | | | |
|---|---|---|---|---|
| COEFFICIENT | SURFACE NUMBER | | | |
| | FIRST SURFACE | SECOND SURFACE | THIRD SURFACE | FOURTH SURFACE |
| K | 8.1039080E−02 | 9.9000000E+01 | 4.9411473E+01 | 1.2868945E+01 |
| A3 | 5.4383859E−03 | −2.1765353E−03 | 1.0542034E−02 | 3.5381917E−02 |
| A4 | 8.9428344E−03 | 6.5588570E−02 | 2.0952639E−02 | −8.3856898E−02 |
| A5 | 4.9177098E−02 | −7.8901644E−02 | −2.5455191E−02 | 1.5539783E−01 |
| A6 | −7.7888977E−02 | 1.7981188E−02 | 7.9950848E−02 | −1.0081804E−01 |
| A7 | 7.8940003E−02 | 7.9464766E−02 | −1.065104GE−01 | −2.8117322E−02 |
| A8 | −3.4855155E−02 | −1.2588891E−01 | −8.3542972E−02 | 2.0497024E−02 |
| A9 | 2.2404007E−02 | −4.3837909E−02 | 8.7501403E−02 | 2.7011982E−02 |
| A10 | −3.1727899E−02 | 7.2744364E−02 | 1.6994977E−02 | −2.2564464E−03 |
| | FIFTH SURFACE | SIXTH SURFACE | SEVENTH SURFACE | EIGHTH SURFACE |
| K | 9.6534599E+00 | −7.9114040E+00 | −5.0000000E+01 | −6.9345484E+00 |
| A3 | 3.0715653E−03 | −1.6586590E−01 | −2.0652292E−01 | −9.1155357E−02 |
| A4 | −5.1710265E−02 | 1.0374925E−03 | 6.2271467E−02 | 3.5850334E−02 |
| A5 | 1.9743229E−02 | 5.2578027E−02 | 2.7369223E−03 | −4.9251413E−02 |
| A6 | −5.0244178E−03 | −1.0903066E−02 | −1.1606664E−02 | 5.3619453E−02 |
| A7 | −3.3771468E−02 | −8.6757512E−03 | 2.6496030E−02 | −3.4447741E−02 |
| A8 | 8.9056173E−03 | −1.2835441E−03 | −1.4565919E−02 | 1.3215706E−02 |
| A9 | 3.2376353E−02 | 2.9883926E−03 | 2.2111090E−03 | −3.0498597E−03 |
| A10 | −3.0353374E−02 | 3.3784770E−05 | 7.4339529E−05 | 3.3646857E−04 |

TABLE 21
EXAMPLE 11 - BASIC LENS DATA

| Si | Ri | Di | Ndj | ν dj |
|---|---|---|---|---|
| (SURFACE NUMBER) | (RADIUS OF CURVATURE) | (SURFACE SEPARATION) | (REFRACTIVE INDEX) | (ABBE NUMBER) |
| 0 (APERTURE) | — | −0.20 | | |
| 1 | 1.521 | 0.680 | 1.510 | 56.4 |
| 2 | −10.253 | 0.101 | | |
| 3 | −11.734 | 0.441 | 1.614 | 25.3 |
| 4 | 4.003 | 0.886 | | |
| 5 | −3.244 | 1.158 | 1.534 | 55.9 |
| 6 | −1.617 | 0.221 | | |
| 7 | −1778.145 | 0.641 | 1.534 | 55.9 |
| 8 | 1.746 | 0.550 | | |
| 9 | ∞ | 0.300 | 1.516 | 64.1 |
| 10 | ∞ | 0.427 | | |

(f = 4.923 mm, FNo. = 2.80)

TABLE 22
EXAMPLE 11 - ASPHERICAL SURFACE DATA

| ASPHERICAL | | | | |
|---|---|---|---|---|
| COEFFICIENT | SURFACE NUMBER | | | |
| | FIRST SURFACE | SECOND SURFACE | THIRD SURFACE | FOURTH SURFACE |
| K | 3.0912076E−01 | 9.9000000E+01 | 4.9411473E+01 | 1.5722757E+01 |
| A3 | 1.1668473E−03 | −6.8117892E−03 | 8.3550674E−03 | 3.2053458E−02 |
| A4 | 1.8535645E−02 | 8.4415688E−02 | 4.4376284E−02 | −7.0543491E−02 |
| A5 | 3.6463689E−02 | −7.7747860E−02 | −3.4052089E−02 | 1.5407594E−01 |
| A6 | −8.7953993E−02 | 3.2580422E−03 | 7.0881382E−02 | −1.0947018E−01 |
| A7 | 8.3464741E−02 | 7.4467384E−02 | −1.0613655E−01 | −3.1521735E−02 |
| A8 | −1.7134795E−02 | −1.1588457E−01 | −8.0059572E−02 | 2.6785446E−02 |
| A9 | 3.4058579E−02 | −3.1097117E−02 | 9.1193782E−02 | 2.8023516E−02 |
| A10 | −5.5815914E−02 | 5.9047207E−02 | 1.4751780E−02 | −2.4037157E−03 |
| | FIFTH SURFACE | SIXTH SURFACE | SEVENTH SURFACE | EIGHTH SURFACE |
| K | 7.4374837E+00 | −6.5605190E+00 | −5.0000000E+01 | −7.0840257E+00 |
| A3 | 1.6302341E−03 | −1.5570747E−01 | −2.0556191E−01 | −9.0129017E−02 |
| A4 | −4.7734212E−02 | −4.5353729E−03 | 6.1777625E−02 | 3.8203033E−02 |
| A5 | 1.4054647E−02 | 5.1319008E−02 | 8.8000004E−03 | −5.8769630E−02 |
| A6 | −9.9161797E−03 | −1.1285403E−02 | −2.2925939E−02 | 6.9048473E−02 |
| A7 | −3.5135565E−02 | −8.9697035E−03 | 3.8320977E−02 | −4.8287559E−02 |
| A8 | 1.2898713E−02 | −1.3675503E−03 | −2.1799702E−02 | 2.0394354E−02 |
| A9 | 3.7063187E−02 | 3.1405340E−03 | 4.4082853E−03 | −5.0468925E−03 |
| A10 | −3.7852453E−02 | 3.3304124E−04 | −1.7142178E−04 | 5.6252405E−04 |

### [Other Numerical Data of Each Example]

[Table 23] summarizes values related to each conditional expression for each Example. As shown in [Table 23], the value of each Example falls within the numerical range of each conditional expression.

TABLE 23
LIST OF CONDITIONAL EXPRESSIONS

| | CONDITIONAL | | | | | |
|---|---|---|---|---|---|---|
| | EXPRESSION | CONDITIONAL | CONDITIONAL | CONDITIONAL | CONDITIONAL | CONDITIONAL |
| | (1) | EXPRESSION | EXPRESSION | EXPRESSION | EXPRESSION | EXPRESSION |
| | \| (R4 + R3)/ | (2) | (3) | (4) | (5) | (6) |
| | (R4 − R3) \| | \| f4/f \| | f1/f | f3/f | \| f2/f \| | ν1 − ν2 |
| EXAMPLE 1 | 0.992 | 0.487 | 0.672 | 0.530 | 1.149 | 31.3 |
| EXAMPLE 2 | 0.699 | 0.587 | 0.534 | 0.802 | 0.957 | 31.1 |
| EXAMPLE 3 | 1.000 | 0.417 | 0.661 | 0.421 | 1.050 | 31.1 |
| EXAMPLE 4 | 1.441 | 0.452 | 0.823 | 0.521 | 1.712 | 30.6 |
| EXAMPLE 5 | 0.821 | 0.521 | 0.675 | 0.618 | 1.101 | 29.5 |
| EXAMPLE 6 | 0.761 | 0.520 | 0.671 | 0.617 | 1.096 | 29.5 |
| EXAMPLE 7 | 0.985 | 0.516 | 0.650 | 0.618 | 1.098 | 29.5 |
| EXAMPLE 8 | 0.999 | 0.427 | 0.684 | 0.445 | 1.086 | 30.6 |
| EXAMPLE 9 | 0.364 | 0.668 | 0.520 | 1.022 | 0.943 | 31.1 |
| EXAMPLE 10 | 0.609 | 0.650 | 0.550 | 0.938 | 0.987 | 31.1 |
| EXAMPLE 11 | 0.491 | 0.663 | 0.538 | 0.983 | 0.977 | 31.1 |

### [Aberration Performance]

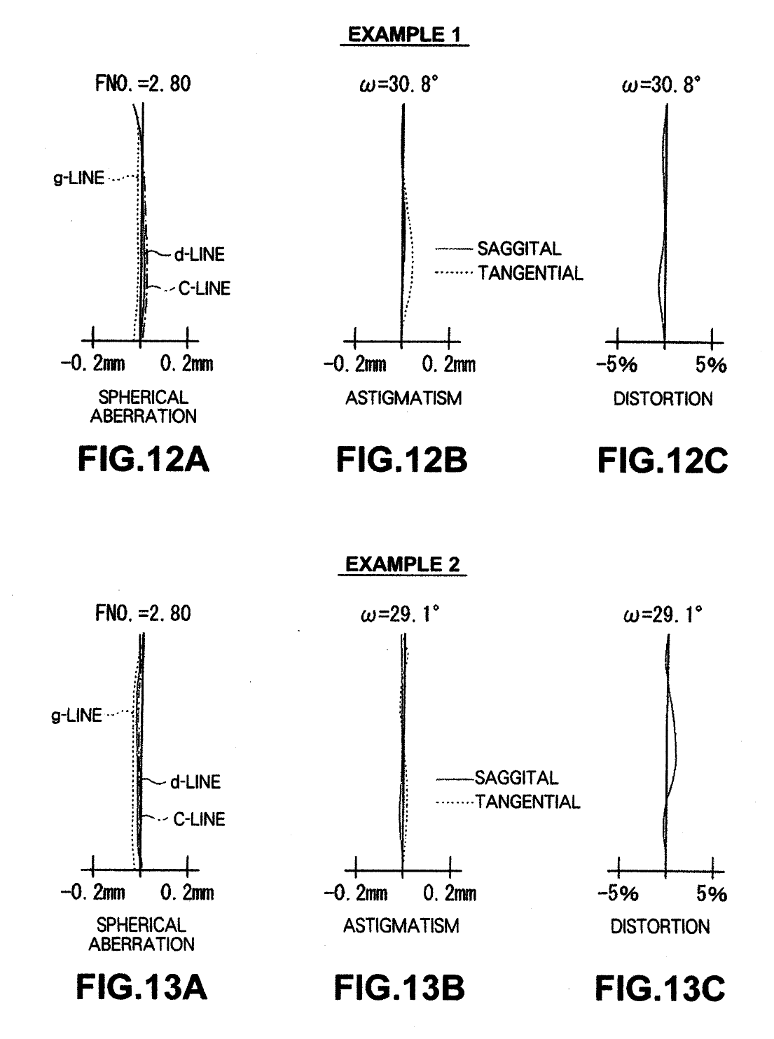

The spherical aberration, astigmatism, and distortion of image pickup lens according to Example 1 are shown in FIGS. 12A to 12C respectively. Each aberration diagram shows the aberration with d-line (wavelength of 587.6 nm) as the reference wavelength. The spherical aberration diagram also illustrates the aberrations with respect to g-line (wavelength of 435.8 nm) and C-line (wavelength of 656.3 nm). In the astigmatism diagram, the solid line indicates the aberration in the saggital direction and the dotted line indicates the aberration in the tangential direction. The “FNo.” represents an F-number and “ω” represents a half angle of view.

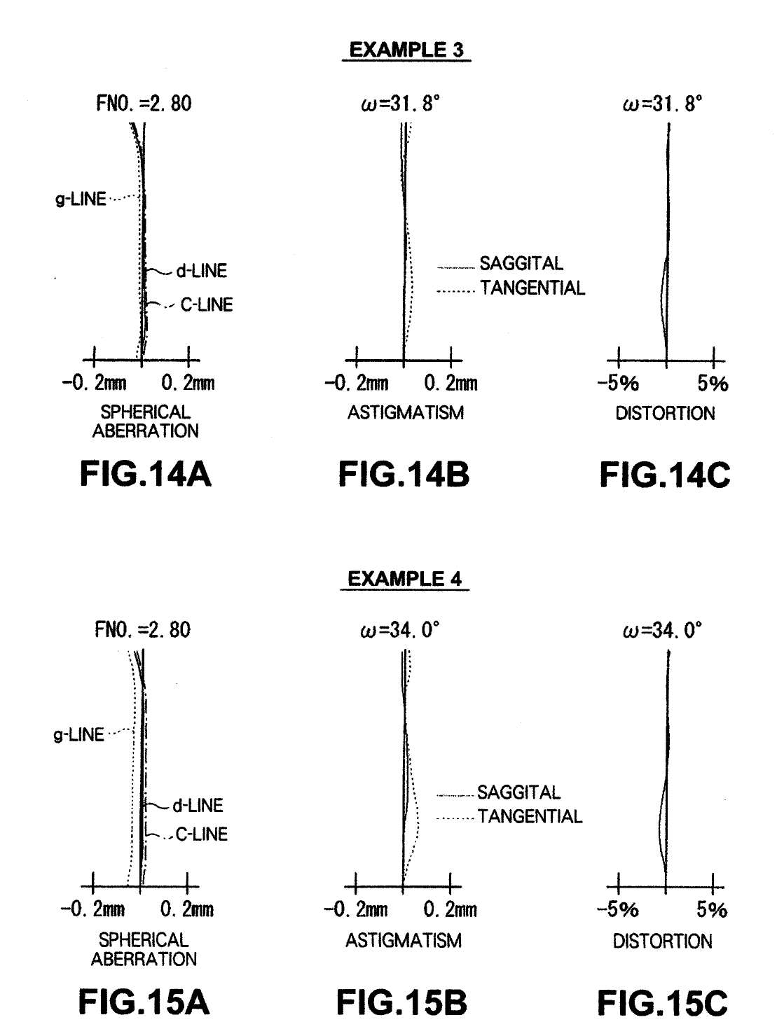

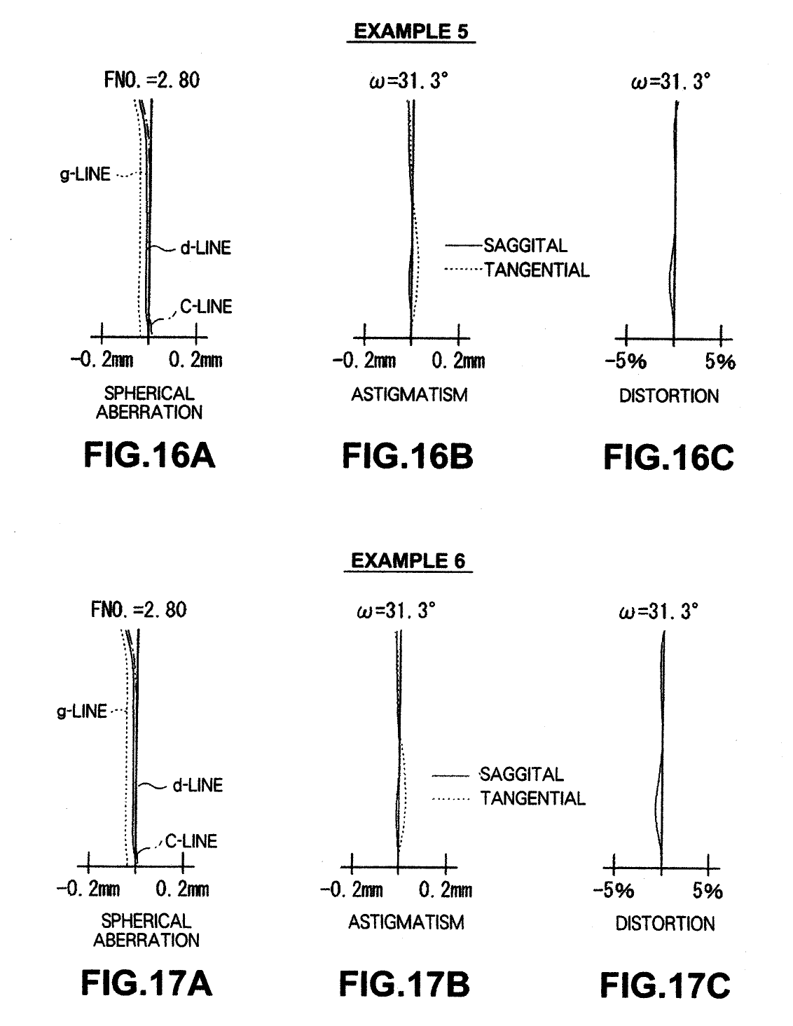

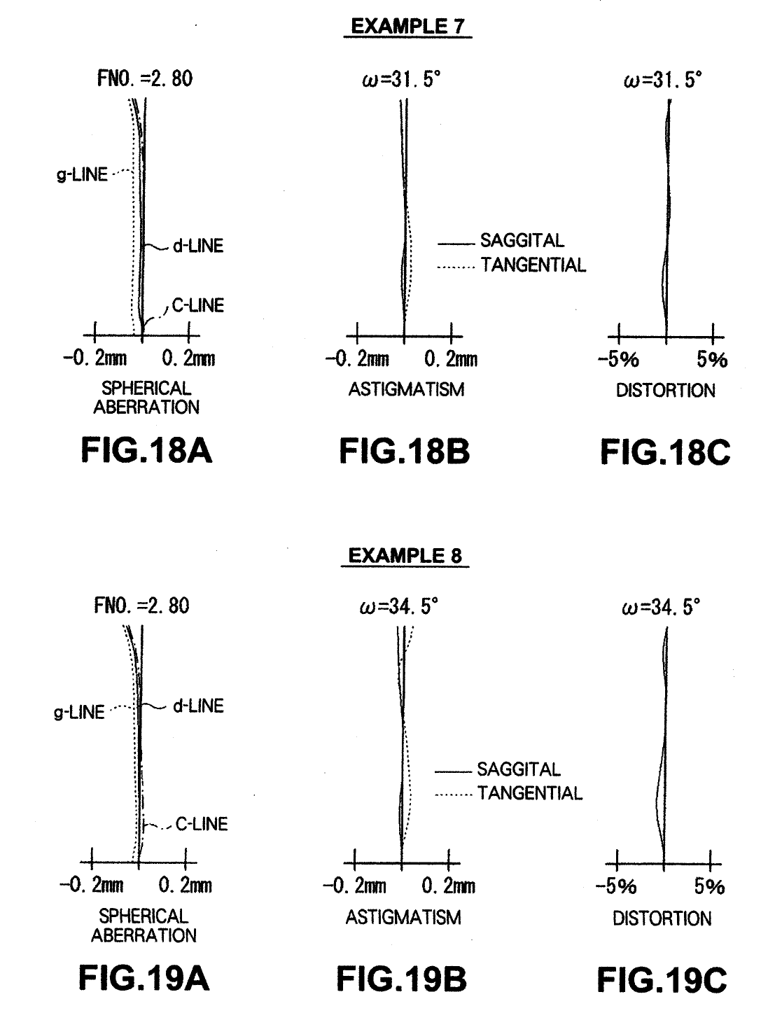

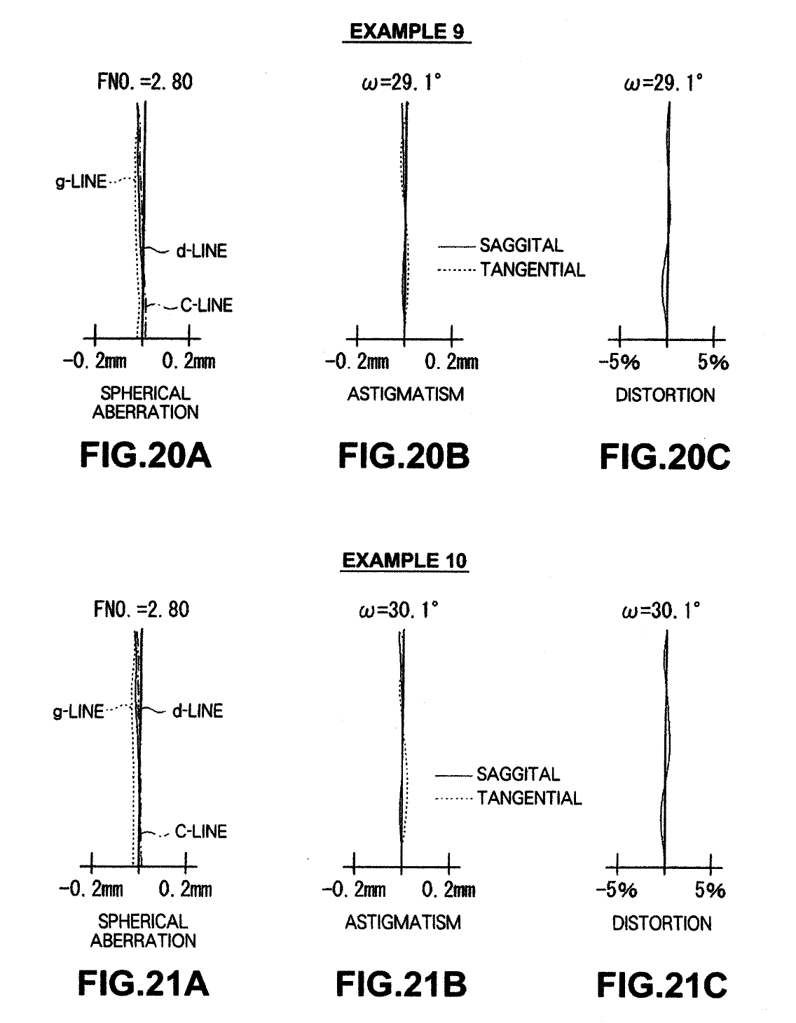

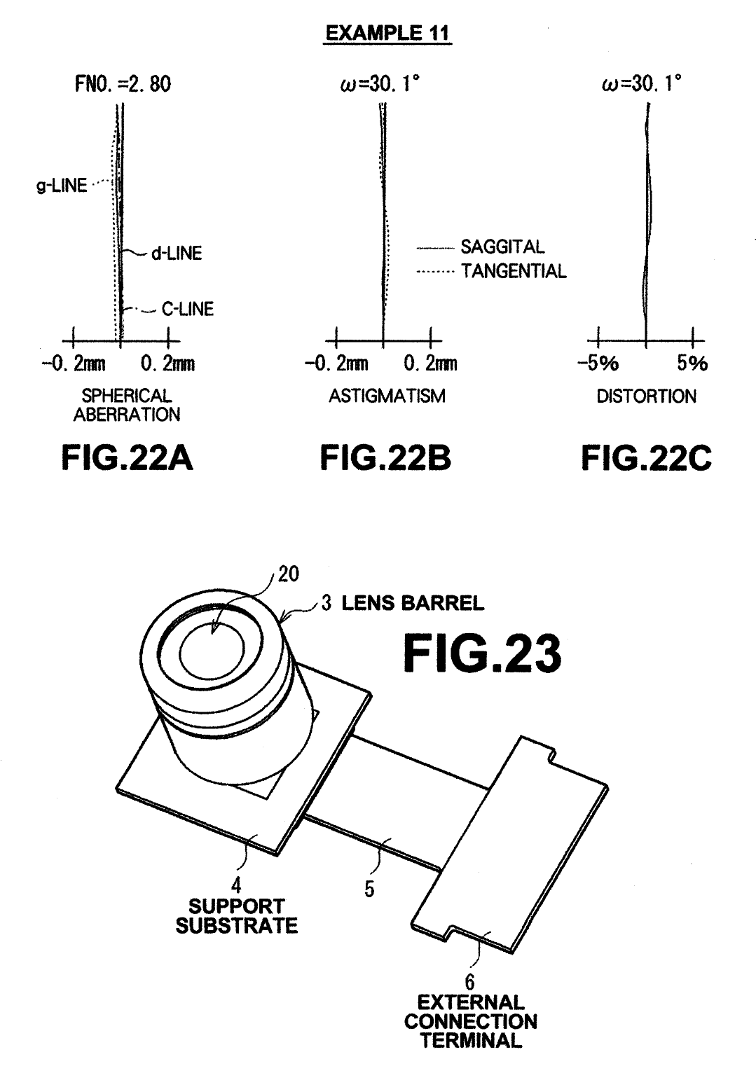

Likewise, the spherical aberration, astigmatism, and distortion of image pickup lens according to Example 2 are shown in FIGS. 13A to 13C respectively. Further, spherical aberrations, astigmatisms, and distortions of image pickup lenses according to Example 3 to 11 are shown in FIGS. 14A, 14B, 14c to 22A, 22B, 22C respectively.

As is clear from the numerical data and aberration diagrams, the total length reduction and high image forming performance are realized in each Example.

It should be appreciated that the present invention is not limited to the embodiments and Examples described above, and various modifications and changes may be made. For example, values of the radius of curvature, surface separation, and refractive index of each lens element are not limited to those shown in each Numerical Example and may take other values.

1. An image pickup lens, comprising the following disposed from an object side in the order listed below:
a first lens having a positive refractive power;
a second lens having a negative refractive power;
a third lens having a positive refractive power; and
a fourth lens having an object side surface which is concave or flat adjacent to an optical axis of the lens and a negative refractive power adjacent to the optical axis,
wherein the lens satisfies Conditional Expression (1) given below.
0.3<|(R4+R3)/(R4−R3)|<1.5 (1)
where,
R3 is a paraxial radius of curvature of an object side surface of the second lens, and
R4 is a paraxial radius of curvature of an image side surface of the second lens.

2. The image pickup lens of claim 1, further satisfying Conditional Expression (2) given below.
0.3<|f4/f|<0.80 (2)
where,
f is an overall focal length, and
f4 is a focal length of the fourth lens.

3. The image pickup lens of claim 1, further satisfying Conditional Expression (3) given below.
0.4<f1/f<1.1 (3)
where,
f: an overall focal length; and
f1: a focal length of the first lens.

4. The image pickup lens of claim 1, further satisfying Conditional Expression (4) given below.
0.2<f3/f<1.6 (4)
where,
f is an overall focal length, and
f3 is a focal length of the third lens.

5. The image pickup lens of claim 1, further satisfying Conditional Expression (5) given below.
0.5<|f2/f|<2.0 (5)
where,
f is an overall focal length, and
f3 is a focal length of the second lens.

6. The image pickup lens of claim 1, further satisfying Conditional Expression (6) given below.
20<ν1−ν2 (6)
where,
ν1 is an Abbe number of the first lens with respect to d-line, and
ν2 is an Abbe number of the second lens with respect to d-line.

7. The image pickup lens of claim 1, further comprising an aperture disposed on the object side of a surface apex position of an image side surface of the first lens on the optical axis.

8. The image pickup lens of claim 1, wherein an image side surface of the fourth lens has a concave shape adjacent to the optical axis and a region in which the negative refractive power becomes weak toward the periphery in comparison with a region adjacent to the optical axis.

9. The image pickup lens of claim 8, wherein the image side surface of the fourth lens has an aspherical shape having an inflexion point within an effective diameter.

10. The image pickup lens of claim 8, wherein the image side surface of the fourth lens has an aspherical shape having a pole at a position other than the center of the optical axis within an effective diameter.

11. An image pickup apparatus, comprising:
the image pickup lens of claim 1; and
an image sensor for outputting an imaging signal according to an optical image formed by the image pickup lens.

12. A portable terminal device, comprising:
the image pickup apparatus of claim 11; and
a display unit for displaying an image taken by the image pickup apparatus.

13. An image pickup apparatus, comprising:
the image pickup lens of claim 1; and
an image sensor for outputting an imaging signal according to an optical image formed by the image pickup lens.

14. An image pickup apparatus, comprising:
the image pickup lens of claim 1; and
an image sensor for outputting an imaging signal according to an optical image formed by the image pickup lens.

15. An image pickup apparatus, comprising:
the image pickup lens of claim 1; and
an image sensor for outputting an imaging signal according to an optical image formed by the image pickup lens.

16. An image pickup apparatus, comprising:
the image pickup lens of claim 1; and
an image sensor for outputting an imaging signal according to an optical image formed by the image pickup lens.

17. An image pickup apparatus, comprising:
the image pickup lens of claim 1; and
an image sensor for outputting an imaging signal according to an optical image formed by the image pickup lens.

18. An image pickup apparatus, comprising:
the image pickup lens of claim 1; and
an image sensor for outputting an imaging signal according to an optical image formed by the image pickup lens.

19. An image pickup apparatus, comprising:
the image pickup lens of claim 1; and
an image sensor for outputting an imaging signal according to an optical image formed by the image pickup lens.

20. An image pickup apparatus, comprising:
the image pickup lens of claim 1; and
an image sensor for outputting an imaging signal according to an optical image formed by the image pickup lens.
